(19) United States
(12) Patent Application Publication
(10) Pub. No.: US 2026/0289087 A1
(43) Pub. Date: Sep. 24, 2026

(54) SYSTEM

(71) Applicant: SoftBank Group Corp., Tokyo (JP)

(72) Inventor: Shinji OWAKI, Tokyo (JP)

(73) Assignee: SoftBank Group Corp., Tokyo (JP)

(21) Appl. No.: 19/567,066

(22) Filed: Mar. 14, 2026

(30) Foreign Application Priority Data
Mar. 19, 2025 (JP) 2025-045140

(51) Int. Cl. G06F 40/166; G06F 40/284; G06F 40/30

(52) U.S. Cl. CPC G06F 40/166; G06F 40/284; G06F 40/30

(57) ABSTRACT

A system includes a processor that is configured to receive text data, analyze the received text data to detect a character count and a number of bullet points, determine whether at least one threshold is exceeded based on an analysis result of the character count and the number of bullet points, generate a prompt for instructing a generative AI model to generate a revision proposal when it is determined that the at least one threshold is exceeded, and input the prompt to the generative AI model to cause the generative AI model to generate the revision proposal.

### CROSS-REFERENCE TO RELATED APPLICATION

This application is based on and claims priority under 35 USC 119 from Japanese Patent Application No. 2025-045140 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In text-based communication environments such as chat systems, email systems, and online collaboration platforms, users frequently create text that is excessively long, contains an excessive number of bullet points, or is otherwise difficult for recipients to read and understand efficiently. Conventional systems generally do not automatically analyze such text data to determine whether it exceeds an appropriate complexity level, nor do they provide automatic and context-aware revision proposals. As a result, users may post text that is verbose, poorly structured, or overly detailed, which can reduce communication efficiency, increase the cognitive burden on readers, and lead to misunderstandings. Furthermore, even when generative AI models are available, there is no integrated mechanism for automatically detecting when revision is desirable and for generating suitable prompts that cause the generative AI models to produce effective revision proposals based on objective analysis criteria such as character count and number of bullet points. Therefore, there is a need for a system that automatically analyzes text data, determines when the text exceeds one or more predetermined thresholds, and cooperates with a generative AI model to generate and present appropriate revision proposals to a user or an author of the text.

### SUMMARY

In order to solve the above-described problems, according to one aspect of the present invention, there is provided a system comprising a processor, wherein the processor is configured to receive text data, analyze the received text data to detect a character count and a number of bullet points, determine whether at least one threshold is exceeded based on an analysis result of the character count and the number of bullet points, generate a prompt for instructing a generative AI model to generate a revision proposal when it is determined that the at least one threshold is exceeded, and input the prompt to the generative AI model to cause the generative AI model to generate the revision proposal. In some embodiments, the processor is further configured to present the generated revision proposal via a user interface, so that a user can view and selectively adopt the revision proposal. In some embodiments, the processor is further configured to notify an author of the text data of the generated revision proposal via a communication module, thereby enabling the author to recognize that the original text exceeded the threshold and to revise the original text with reference to the revision proposal generated by the generative AI model.

The term “text data” refers to character-based content including, but not limited to, sentences, paragraphs, and lists that are input, stored, transmitted, or processed by the system for purposes of text-based communication or document creation.

The term “character count” refers to a numerical value representing the number of characters, symbols, or code points contained in a given piece of text data, and may include or exclude whitespace characters depending on a predetermined counting rule.

The term “bullet points” refers to list elements in the text data that are indicated as individual items by specific markers, such as hyphens, asterisks, numbered labels, or other list indicators, and that are treated as discrete units in a list structure.

The term “threshold” refers to a predetermined numerical value or set of numerical values, such as a maximum allowable character count or a maximum allowable number of bullet points, used as a criterion to determine whether the complexity or length of the text data requires generation of a revision proposal.

The term “analysis result” refers to information obtained by the processor through processing of the text data, including at least the detected character count and number of bullet points, and optionally additional metrics derived from the text data.

The term “prompt” refers to text or structured data generated by the processor and supplied as input to a generative AI model, the prompt including instructions or contextual information that cause the generative AI model to generate a revision proposal for the text data.

The term “generative AI model” refers to a machine learning model, such as a large language model or other neural network-based generative model, configured to generate text outputs, including revision proposals, in response to input prompts.

The term “revision proposal” refers to text generated by the generative AI model that suggests one or more modifications to the original text data, such as shortening, rephrasing, restructuring, or reorganizing bullet points, in order to improve readability, conciseness, or clarity.

The term “user interface” refers to a hardware and/or software interface, including graphical user interfaces, text-based interfaces, or web interfaces, through which a user can view the revision proposal and optionally interact with the system.

The term “communication module” refers to a functional component, implemented in hardware, software, or a combination thereof, that transmits information, including the revision proposal, to an external device or user via a communication network such as the Internet, a local area network, or a wireless communication network.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

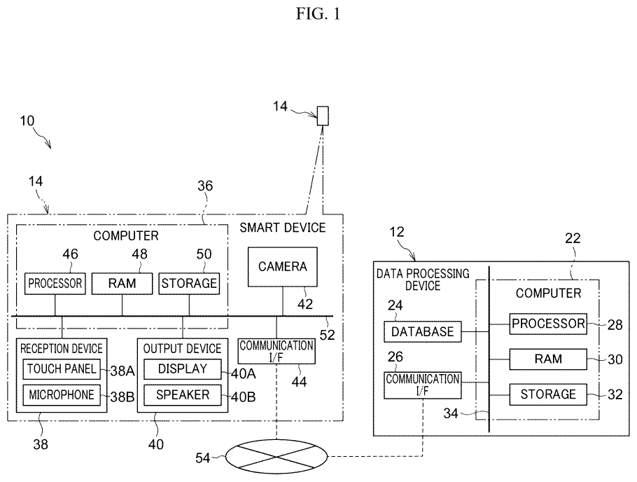

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

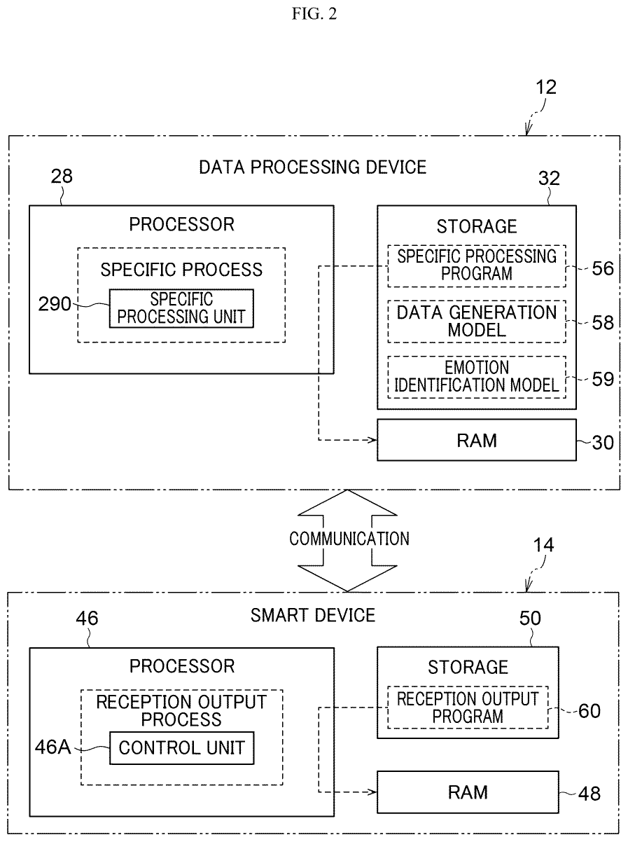

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

In online communication environments, users frequently compose text that is unnecessarily long or overly fragmented into list structures, such as bullet points or numbered items. Conventional text editing tools typically rely on static rules, such as simple character limits or keyword-based checks, and either truncate content or display generic warnings when text becomes lengthy or complex. These conventional approaches suffer from several technical drawbacks.

First, conventional systems generally do not perform structured analysis of both character-length information and list-structure element counts in a coordinated manner. As a result, such systems cannot accurately characterize the structural complexity of text data and cannot adapt their behavior based on the actual composition of the text. Second, even when some analysis is performed, conventional systems merely return simple notifications to a user terminal and do not generate machine-adaptive instructions for downstream processing components. In particular, they do not construct machine-oriented prompt sentences that condition a generative AI model based on detailed analysis results, and therefore cannot effectively use generative models as part of a feedback loop for improving text structure.

Third, conventional architectures treat any external language model or AI service as a black box that receives only raw text, without exposing internal analysis metrics such as measured character length, detected list-structure complexity, or configured thresholds. This causes the external model to behave in a generic way, independent of the system's own structural assessment of the text. Consequently, the generated revisions are often misaligned with the system's technical constraints or user-interface requirements, and additional post-processing logic is required on the server side, increasing computational load and latency.

Fourth, when a generative AI model is used, conventional systems do not maintain systematic associations between (i) analysis results, (ii) thresholds used for decision-making, and (iii) revision proposals returned from the model. This prevents fine-grained auditing, tuning, or reuse of previous interactions and makes it technically difficult to improve model prompts or threshold logic over time. Furthermore, the absence of structured storage of such associations limits the ability of the system to iteratively refine its own control flow based on historical behavior, thereby reducing responsiveness and predictability of the server's text-processing pipeline.

Accordingly, there is a need for a technical solution that improves the functioning of a server in text-processing workflows by: (i) performing coordinated analysis of character-length information and list-structure elements; (ii) dynamically determining and applying thresholds based on such analysis; (iii) generating structured prompt sentences that explicitly encode analysis results and threshold information for a generative AI model; (iv) integrating the resulting revision proposals into a coherent feedback message; and (v) storing and associating analysis results, thresholds, and revision proposals on a recording medium. Such a solution would enable the server to operate as an integrated text-optimization engine that programmatically controls a generative AI model, thereby improving computational efficiency, consistency of revision output, and usability of the feedback presented to a communication terminal.

The specific processing by the specific processing unit 290 of the data processing device 12 in Example 1 is realized by the following means.

The present invention provides a server comprising a processor and a memory storing instructions that, when executed by the processor, cause the processor to receive text data from a communication terminal; analyze the received text data to detect a length of character information and a number of elements in a list structure, and obtain an analysis result including the length of the character information and the number of elements in the list structure; determine and set a threshold for the length of the character information and a threshold for the number of elements in the list structure by acquiring or generating the thresholds from a storage device on the basis of the analysis result, and determine whether the analysis result exceeds at least one of the thresholds; when a determination that at least one of the thresholds is exceeded is made, generate a machine-oriented prompt sentence including at least one of text improvement information, threshold information, and the analysis result, generate request data for inputting the prompt sentence to a generative information processing model, and transmit the request data to an external information processing service implementing the generative information processing model; receive response data including a revision proposal generated by the generative information processing model on the basis of the prompt sentence, extract the revision proposal from the response data, and format the revision proposal as improvement information for the text data; store, in a recording medium, the analysis result, the thresholds, and the revision proposal in association with one another; and generate feedback information including the analysis result and the revision proposal and transmit the feedback information to the communication terminal. This enables the server to technically improve text-processing operations by dynamically controlling invocation of a generative AI model based on structured analysis metrics and thresholds, by generating model-specific prompt sentences that encode system-level constraints, and by integrating and persisting associated analysis results and revision proposals, thereby providing more precise, context-aware, and computationally efficient feedback to the communication terminal.

The term “system” refers to a combination of hardware resources and software resources that cooperate to execute text processing, including at least a processor, a memory, and one or more communication interfaces.

The term “processor” refers to one or more hardware computation units, such as a central processing unit or similar logic circuitry, configured to execute instructions to perform text analysis, threshold determination, prompt generation, communication, and data storage control.

The term “memory” refers to one or more non-transitory storage media, such as semiconductor memory, magnetic storage, or optical storage, that store instructions and data used by the processor.

The term “communication terminal” refers to any user-operated information processing apparatus, such as a client device, capable of transmitting text data to the system and receiving feedback information from the system through a communication network.

The term “text data” refers to digital data including character information that represents sentences, phrases, or list items used in electronic communication.

The term “character information” refers to a sequence of characters encoded in a digital format representing human-readable text, where the length of the character information is expressed as a count of characters.

The term “list structure” refers to a structural arrangement of text in which a plurality of elements are enumerated, including but not limited to bullet lists, numbered lists, or similar itemized text formats.

The term “number of elements in a list structure” refers to a count of individual items or entries forming the list structure within the text data.

The term “analysis result” refers to information obtained by processing the text data, including at least a measured length of the character information and a detected number of elements in the list structure.

The term “threshold” refers to a reference value used as a criterion for determining whether a measured value, such as the length of the character information or the number of elements in the list structure, is excessive or within an acceptable range.

The term “storage device” refers to a hardware component or subsystem, such as a database system or file storage unit, that stores thresholds, configuration information, and historical processing data.

The term “recording medium” refers to a non-transitory physical medium, such as a magnetic disk, optical disk, or semiconductor memory, on which the analysis result, thresholds, and revision proposals are stored in an associated manner.

The term “determination” refers to a logical operation executed by the processor that compares the analysis result with one or more thresholds to decide whether a particular condition, such as threshold exceedance, is satisfied.

The term “prompt sentence” refers to a machine-readable instruction text generated by the processor, including at least a part of the analysis result or threshold information, and used as an input condition for a generative information processing model.

The term “prompt pattern” refers to a predefined structural template or format for constructing a prompt sentence, selected based on one or more characteristics of the text data or the analysis result.

The term “generative information processing model” refers to a computational model, such as a generative AI model implemented on an external information processing service, configured to generate new text data, including revision proposals, in response to a given prompt sentence.

The term “external information processing service” refers to a network-accessible computing service, separate from the system, that executes the generative information processing model and returns output data based on received request data.

The term “request data” refers to a structured data set generated by the processor, including at least the prompt sentence and model parameters, and transmitted to the external information processing service to invoke the generative information processing model.

The term “response data” refers to structured data received from the external information processing service, the data including at least one revision proposal generated by the generative information processing model based on the prompt sentence.

The term “revision proposal” refers to text data generated by the generative information processing model that represents an improved or modified version of the original text data, such as a summary, simplification, or reorganized list structure.

The term “improvement information for the text data” refers to information derived from the revision proposal, optionally formatted or post-processed by the processor, that can be used to replace or modify the original text data.

The term “feedback information” refers to information generated by the processor and transmitted to the communication terminal, including at least a portion of the analysis result and at least a portion of the revision proposal, and optionally explanation information regarding text simplification or list-structure modification.

The term “explanation information” refers to descriptive text that explains to a user why a revision is suggested, such as an indication that the character length exceeds a threshold or that the list structure contains too many elements.

The term “summary text” refers to a shortened version of the original text data generated by the generative information processing model, preserving principal content while reducing overall length.

The term “list-reconstructed text” refers to text generated by the generative information processing model in which elements of an original list structure are integrated, reduced, grouped, or otherwise reorganized to improve readability or conciseness.

In one embodiment, a server implements the claimed system by cooperating with one or more terminals operated by users. The server includes at least one processor, such as a multicore central processing unit, at least one memory device including volatile memory and non-volatile storage, and at least one communication interface connected to a packet-based communication network. The terminal includes a user interface device, such as a display and input peripherals, and a communication module configured to send text data to the server and receive feedback information from the server.

The server executes an operating system, such as a general-purpose server operating system, and runs application software implemented, for example, using a programming language interpreter or runtime. In one concrete implementation, the server runs a Python interpreter on an operating system such as a Unix-like system. The server executes an application framework, such as a web application framework, that exposes an application programming interface to the terminal. The server stores configuration data, thresholds, and historical text-analysis records in a relational database management system such as a structured query system.

The server analyzes text data by using a natural language processing library executing on the processor. In one implementation, the server loads a language model from a library such as a statistical or neural NLP toolkit (for example, spaCy or a similar toolkit) to tokenize sentences and detect list structures. The server accesses string-processing libraries and regular-expression engines provided by the runtime environment to detect characters and patterns in the text. The server maintains data structures in memory, such as arrays, hash maps, and records, to store an analysis result that includes a character count and a count of list-structure elements.

The server processes the text data to determine structural complexity and to generate a machine-oriented prompt sentence for a generative AI model. The server constructs the prompt sentence by concatenating several fields: an instruction portion specifying an operation such as summarization, simplification, or list reorganization; a metrics portion indicating the measured character length, list-element count, and threshold values; and a content portion including the user's original text. The server chooses a particular prompt pattern by evaluating the analysis result against a configuration table of prompt templates. This selection is not performed by a human operator but is performed algorithmically by the server based on the structural properties of the text.

The server uses a generative AI model that is implemented as a deep neural network. In one example, the generative AI model is a Transformer-based language model with multiple encoder-decoder layers, self-attention mechanisms, and position-wise feedforward networks. The server interacts with this model through an external information processing service that hosts the neural network on specialized hardware such as graphics processors or tensor accelerators. The generative AI model has been trained in advance on a large text corpus using supervised or unsupervised learning. During training, the model minimizes a loss function such as cross-entropy between predicted token distributions and ground-truth tokens. The external service updates model parameters, including weight matrices in attention layers, bias vectors, and normalization parameters, by applying optimization algorithms such as stochastic gradient descent or adaptive moment estimation. During inference, the external service executes forward passes through the network without updating weights, computing token probabilities through attention and feedforward transformations.

The server transmits request data to the external information processing service over a secure communication channel. The request data includes the prompt sentence, model selection parameters (such as a model identifier, decoding temperature, maximum output length, and stopping criteria), and optional context metadata. The external generative AI model produces a revision proposal by sequentially sampling or decoding tokens according to the learned probability distributions. The server receives the resulting revision proposal as part of response data and decomposes the response into structured fields, extracting the generated text segment to use as the revision proposal.

The server does not rely solely on generic use of a language model but integrates the model with an internal control loop that exploits the server's structural analysis results. The server embeds threshold values and measured metrics directly into the prompt sentence, thereby constraining the generative AI model to produce text that satisfies particular structural targets. For example, when the character count is significantly greater than a character-threshold value and the list-element count exceeds a list-threshold value, the server selects a prompt pattern instructing the model to reduce both length and list complexity. Because the prompt encodes precise metrics, the generative AI model can adjust the density of information and number of bullet-point items more accurately than in conventional systems where the model receives only the raw text.

In one concrete example, the user inputs a long project description at the terminal. The terminal displays an input field on a web page or within a mobile application and sends the entered text to the server. The server measures a character length of, for example, 860 characters and detects 9 list-like elements. The server has configured thresholds such that a character-length threshold is 500 characters and a list-element threshold is 5 elements. The server detects that both thresholds are exceeded and therefore selects a prompt pattern for joint simplification and list reduction.

In this case, the server generates a prompt sentence such as:

“You are an assistant that revises user text for online communication.

The user's text is too long or has too many bullet points.
Character count: 860
Bullet point count: 9
Character threshold: 500
Bullet threshold: 5

Please rewrite the text to be more concise and easier to read.
1. Preserve all important information.
2. Remove redundancies and overly detailed explanations.
3. Use clear and simple sentences.
4. Reduce the number of bullet points if possible.

Here is the original text:

[User's original text here]”

The server includes this prompt sentence in the request data and transmits it to the generative AI model. The generative AI model outputs a revision proposal that reduces redundancy, reorganizes list items, and shortens sentences. The server extracts the revision proposal and formats it as improvement information. The server then assembles feedback information including at least the original metrics, the thresholds, explanation information regarding why revision was recommended, and the revision proposal. The terminal receives the feedback information and displays both the original text and the revised text so that the user can review and optionally adopt the suggested revision.

In another example, the user composes a message that is within the character-length threshold but has many discrete bullet points. The server detects a list-element count of 12 with a list-element threshold of 5. The server chooses a prompt sentence focused on list restructuring:

“The following text contains too many bullet points.

Please reduce the number of bullet points and group related items together.

Keep the tone polite and professional.

Original text:

[User's original text here]”

The generative AI model uses this prompt sentence to merge related list items and group subtopics into fewer bullet points, thereby reducing visual fragmentation. The server's use of explicit list-element counts and thresholds in the prompt sentence causes the generative AI model to focus on structural simplification, which conventional, generic summarization prompts would not necessarily achieve.

The server improves computer technology by implementing a non-trivial orchestration between deterministic analysis logic and stochastic generative modeling. The server's analysis module computes precise structural metrics (character length, list-element count) using optimized string-processing and pattern-matching operations. These metrics are stored in indexed data structures on non-transitory media, allowing the server to reuse them without recomputation and to adjust thresholds adaptively over time. By only invoking the generative AI model when thresholds are exceeded, the server reduces computational load on both the local processor and the external service, resulting in improved throughput and latency compared with systems that indiscriminately submit all text to a generative model.

Moreover, the server improves the accuracy of generative output by conditioning the model with fine-grained structural constraints embedded in the prompt sentence. Because the prompt sentence includes explicit metrics and target constraints, the generative AI model can allocate attention to structural elements (such as sentence boundaries and list markers) that are relevant to the server's objectives. This targeted conditioning reduces the need for repeated trial-and-error calls to the model and decreases the amount of post-processing the server must perform on the resulting text.

The server also improves data management by storing, in association on a recording medium, the analysis result, thresholds, prompt pattern identifiers, and revision proposals. This association allows the server to analyze historical performance of different prompt patterns and threshold settings. The server can aggregate statistics on model-output lengths, list-element counts after revision, and user-acceptance rates. Based on these statistics, the server can adjust threshold values and prompt-pattern selection rules in a manner that reduces variance of output length and improves conformity to desired structures. This adaptive tuning is executed by the server using algorithmic rules and is not a simple substitution for manual human editing.

From an architectural perspective, the server comprises multiple logical modules stored in memory and executed by the processor: a text input module, an analysis module, a threshold management module, a prompt generation module, a model communication module, a response processing module, a data persistence module, and a feedback generation module. Each module operates on well-defined data structures. For example, the analysis module operates on a text record that includes a text identifier, the raw text buffer, language attributes, and a list-structure descriptor. The threshold management module operates on a configuration record that stores threshold values by document type and may include hysteresis parameters to avoid oscillation. The prompt generation module operates on a prompt template record that includes an instruction string, placeholders for metrics, and a mapping to a target operation (summarization, simplification, or list reconstruction).

The use of a generative AI model in this system is not a mere automation of human editing. The server uses the model as a controllable computational unit whose behavior is parameterized by machine-detected features. Human editors do not typically compute and encode exact character counts and list-element counts as numerical parameters when revising text; by contrast, the server embeds such metrics into the prompt sentence to drive the generative AI model to produce outputs that satisfy clearly defined structural constraints. This non-human, metric-driven control of a generative model results in more predictable and quantifiable behavior than ad hoc human editing, and improves computational efficiency and accuracy of structural transformations performed on large volumes of text.

The server may employ alternative generative AI architectures in different embodiments. In one embodiment, the generative AI model is an auto-regressive Transformer network with a fixed number of layers and attention heads, trained using masked language modeling. In another embodiment, the generative AI model uses encoder-only or decoder-only architectures and may incorporate additional features such as segment embeddings representing list positions or structural tags. The server can select between different models or model variants based on document type, language, or resource constraints, by encoding such selection into the request data. In all cases, the server maintains the same general control pattern: analyze, threshold, generate a metrics-aware prompt sentence, obtain a revision proposal, and integrate the revision proposal into a structured feedback message.

In further embodiments, the server applies rule-based post-processing to the revision proposal to enforce constraints that the generative AI model alone may not strictly satisfy. For instance, the server may verify that the final character length does not exceed an upper limit and that the final list-element count does not exceed a configured maximum. If the generative AI model's output still violates a constraint, the server can either adjust thresholds and regenerate a new prompt sentence, or apply deterministic algorithms (such as splitting long sentences or merging closely related bullets) to correct residual violations. This layered design, combining deterministic algorithms and probabilistic models, yields improved reliability and control compared with systems that rely on either approach alone.

The terminal remains relatively simple in structure. The terminal displays the original text and the revision proposal, and renders auxiliary indicators such as numerical counters for character length and list-element count. The user may inspect the server-generated explanation information, which might state, for example, “Your text is too long or has too many bullet points. Please consider the following revision.” The user may choose to adopt the revision proposal in whole or in part, or to modify it further and send an updated text back to the server. Through repeated interactions, the server can maintain an efficient text-processing pipeline that leverages both deterministic structural analysis and generative AI capabilities while improving computational performance, structural accuracy, and data management within the server.

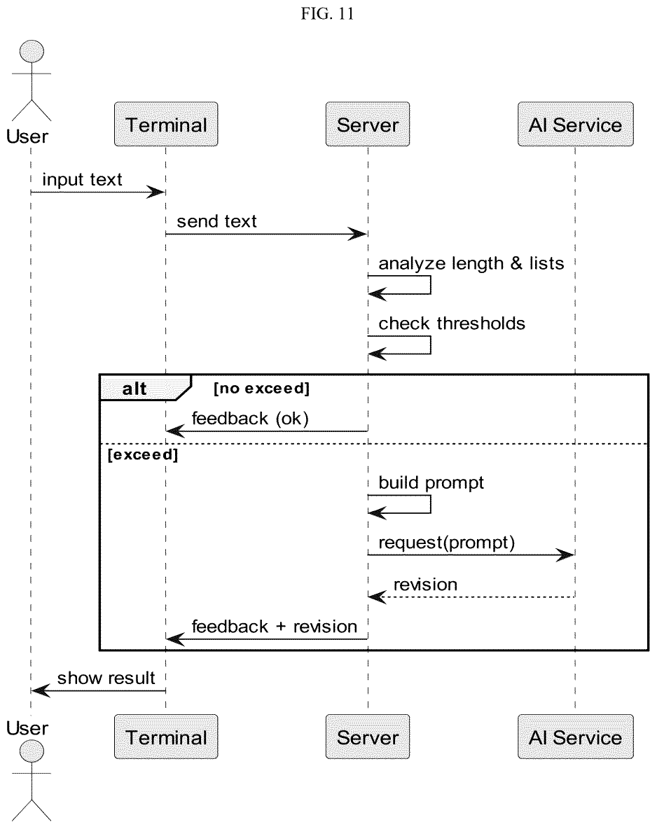

The following describes the processing flow using FIG. 11.

### Step 1:

The terminal displays an input interface and acquires text data from the user.

The terminal presents a text input area and a submission control on a display device. The user types or pastes a message, such as an email draft or project description, into the text area. The terminal sets the entered characters as input text data. As output, the terminal constructs a data object that contains the text string and optional metadata such as language or document type, and stores this object in a local memory buffer for transmission.

### Step 2:

The terminal transmits the text data to the server.

The terminal takes the buffered text object as input and serializes it into a transmission format, for example by embedding the text into a message body of a network request. The terminal establishes a network connection to the server through a communication module and sends the serialized text data as a request message. As output, the terminal produces a network packet stream containing the text data and addressing information directed to the server.

### Step 3:

The server receives the text data and stores it in memory.

The server takes the incoming network packets as input through a communication interface and reconstructs the original request message. The server extracts the text string and associated metadata from the message and writes them into a structured data record in working memory, such as a text record including fields for text identifier, raw text, and language. As output, the server obtains an in-memory representation of the text data that is ready for analysis.

### Step 4:

The server normalizes the text data.

The server uses the in-memory text record as input and applies normalization procedures, such as trimming leading and trailing whitespace, converting line endings to a unified format, and normalizing character encoding. The server may also convert certain full-width characters to half-width characters or perform Unicode normalization. The server stores the normalized string in a separate field of the text record. As output, the server generates a normalized text buffer that serves as the basis for subsequent analysis.

### Step 5:

The server computes the character length of the normalized text.

The server takes the normalized text buffer as input and counts the number of characters in the buffer using string-length operations. The server performs a data operation that iterates over the character sequence and determines a total count value. The server writes this count into an analysis result structure associated with the text record. As output, the server obtains a numerical value representing the length of character information for the text data.

### Step 6:

The server detects list-structure elements in the text.

The server uses the normalized text buffer as input and applies pattern-detection procedures. The server scans the text for list markers such as line prefixes with hyphens or asterisks, numeric prefixes indicating enumerated lists, or other tokens indicating bullet points. The server may also apply sentence segmentation or tokenization to detect sequences that function as list items. The server counts the number of detected list-structure elements and stores this count in the analysis result structure. As output, the server obtains a numerical value representing the number of elements in a list structure within the text data.

### Step 7:

The server aggregates analysis results into a structured record.

The server takes as input the character-length value and the list-element count computed in prior steps. The server combines these values with metadata such as text identifier and language into a single analysis record. The server may write this record to a database or maintain it in an in-memory analysis table. As output, the server obtains a unified analysis result record that encapsulates all structural metrics for the text data.

### Step 8:

The server determines applicable thresholds for the text metrics.

The server uses the analysis result record as input and retrieves threshold information from a configuration store. The server looks up threshold values for character length and list-element count based on document type, user profile, or default settings. The server may also generate threshold values algorithmically if dynamic thresholds are enabled. The server then stores the selected thresholds in a threshold record linked to the text identifier. As output, the server obtains threshold values for both character length and list-structure element count.

### Step 9:

The server compares analysis metrics with thresholds and decides whether revision is required.

The server takes as input the analysis result record and the threshold record. The server performs comparison operations, checking whether the character-length value exceeds the character-length threshold and whether the list-element count exceeds the list-element threshold. The server sets decision flags indicating which thresholds, if any, are exceeded. The server stores these flags in the analysis record. As output, the server obtains a decision result indicating whether at least one threshold is exceeded and therefore whether a revision proposal should be requested.

### Step 10:

The server handles cases where no thresholds are exceeded.

The server uses the decision result as input. If the decision indicates that no thresholds are exceeded, the server generates a feedback information object that includes the analysis metrics and an explanation message stating that the text length and structure are acceptable. The server does not generate a prompt sentence or contact the generative AI model in this case. As output, the server produces feedback information that can be transmitted directly to the terminal without invoking the external model.

### Step 11:

The server selects a prompt pattern based on the decision result.

When the decision result indicates that at least one threshold is exceeded, the server takes the analysis result and threshold record as input and selects an appropriate prompt pattern from a prompt-pattern table. The server applies selection rules such as: if only character length exceeds the threshold, choose a summarization or simplification pattern; if only list-element count exceeds the threshold, choose a list-reorganization pattern; and if both exceed their thresholds, choose a combined simplification and list-reduction pattern. The server records the identifier of the selected prompt pattern. As output, the server obtains a specific prompt pattern ready to be filled with analysis metrics and content.

### Step 12:

The server generates a detailed prompt sentence for the generative AI model.

The server uses the selected prompt pattern, the normalized text buffer, the character-length value, the list-element count, and the threshold values as input. The server substitutes these metrics and the original text into placeholders in the prompt pattern to construct a complete prompt sentence. The server concatenates an instruction part, a metrics description part, and an original-text part into a single textual string. For example, the server may generate a prompt sentence such as:

“You are an assistant that revises user text for online communication.

The user's text is too long or has too many bullet points.
Character count: 860
Bullet point count: 9
Character threshold: 500
Bullet threshold: 5

Please rewrite the text to be more concise and easier to read.
1. Preserve all important information.
2. Remove redundancies and overly detailed explanations.
3. Use clear and simple sentences.
4. Reduce the number of bullet points if possible.

Here is the original text:

[User's original text here]”

The server stores this prompt sentence in a prompt record. As output, the server obtains a completed prompt sentence that encodes both structural metrics and revision instructions.

### Step 13:

The server constructs request data for the generative AI model and transmits it to an external service.

The server takes the prompt sentence and model configuration parameters as input. The server packages the prompt sentence and parameters (such as model name, decoding controls, and maximum output length) into a structured request object. The server then sends this request object over a network connection to an external information processing service that hosts the generative AI model. As output, the server produces and transmits request data that instructs the external model to generate a revision proposal based on the prompt sentence.

### Step 14:

The server receives response data from the external service and extracts the revision proposal. The server uses the incoming network response from the external service as input. The server parses the response data structure and locates the generated textual segment that represents the revision proposal. The server extracts this revision text and stores it in a revision record associated with the original text identifier. As output, the server obtains the revision proposal as a discrete text string that can be further processed.

### Step 15:

The server formats the revision proposal as improvement information for the text data.

The server takes the raw revision proposal and the analysis result as input. The server may apply formatting rules such as trimming extra whitespace, ensuring consistent line breaks, or adjusting list markers to conform to system standards. The server also may verify whether the revised text now satisfies target structural constraints by optionally recomputing character length and list-element count. The server wraps the processed revision text into an improvement-information record. As output, the server obtains a cleaned and structured revision proposal that is suitable for presentation to the user.

### Step 16:

The server stores associated analysis results, thresholds, and revision proposals in persistent storage.

The server uses the analysis result record, threshold record, and revision record as input. The server writes these records into a recording medium, such as a database, in a manner that associates them with a common text identifier. The server may also store the selected prompt pattern identifier and the prompt sentence itself for audit and tuning purposes. As output, the server produces persistent entries that link input metrics, decision logic, and model output in a retrievable form.

### Step 17:

The server generates feedback information to be sent to the terminal.

The server takes the analysis result, thresholds, decision result, and formatted revision proposal as input. The server composes a feedback object containing: numerical values for character length and list-element count; the threshold values; explanation information describing why revision is recommended; and the revision proposal text. If only character length exceeded the threshold, the server emphasizes simplification; if only list-element count exceeded the threshold, the server emphasizes list reorganization; if both exceeded the thresholds, the server describes both issues. As output, the server obtains a feedback information package that provides both diagnostics and suggested improvements.

### Step 18:

The server transmits the feedback information to the terminal.

The server uses the feedback information package as input and encodes it into a response message formatted for the terminal. The server sends this response message via the communication interface back to the originating terminal. As output, the server generates network packets conveying the feedback information, including the revision proposal.

### Step 19:

The terminal receives and displays the feedback information.

The terminal takes the response message from the server as input and decodes the contained feedback object. The terminal extracts elements such as the explanation message, the original metrics, and the revision proposal. The terminal updates the user interface to display the original text, the suggested revised text, and any numerical indicators of length and list complexity. As output, the terminal renders visual content on the display, enabling the user to review the suggested changes.

### Step 20:

The user evaluates the revision proposal and optionally updates the text.

The user views the information displayed by the terminal as input. The user may compare the original text and the revision proposal, decide to accept the revision in whole or in part, or edit the revision further. The terminal allows the user to copy the revision proposal into the main text field or to modify the text directly. As output, the user produces an updated version of the text, which can then be resubmitted to the server, causing the processing sequence to repeat as needed.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented review support systems and text-editing tools mainly rely on simple length counters or static templates, and are not architected to intelligently control interaction between a user terminal and an advanced generative AI model in a way that systematically improves the operation of the computing system itself. For example, existing systems may merely display a remaining character count or reject text exceeding a fixed limit. Such systems do not perform structured analysis of list-like expressions, do not dynamically construct machine-oriented prompt sentences based on measured text characteristics, and do not coordinate low-latency round-trip processing between a server and a generative AI model. As a result, the processing pipeline in the server is often inefficient, the network traffic and computation load are not optimized, and the overall responsiveness and usefulness of AI-based refinement proposals are limited. In particular, when user-generated text includes long passages and excessive list elements, naive integration of a generative AI model can lead to unnecessary or frequent model invocations, increased processing latency, and degraded user experience. Systems that always call a generative AI model regardless of the content characteristics waste computational resources on remote or local AI inference engines and may produce redundant or low-value refinement outputs. Moreover, when server logic does not explicitly associate analysis results with refinement proposals and does not generate structured response information tailored to the user interface behavior on the terminal device, the terminal must perform additional ad hoc processing, which further complicates the client-side software architecture and can increase perceived latency.

Accordingly, there is a need for an improved computer-implemented mechanism that, within a server, programmatically analyzes text information using specific metrics such as character-string length and number of list elements, compares those metrics with configurable reference values, and conditionally generates targeted prompt sentence information for a generative AI model. There is also a need for a coordinated server-side control flow that executes, within a predetermined delay time, (i) text reception, (ii) metric-based analysis, (iii) prompt construction, (iv) model invocation, and (v) transmission of refinement proposal information, so that the system as a whole provides real-time, structured responses. By organizing these operations as a specific sequence of computer-executed steps and by defining a particular data structure for prompt sentences and response information, the invention aims to improve the efficiency, responsiveness, and functional integration of generative AI within text-processing computer systems, rather than merely automating human mental steps.

The specific processing by the specific processing unit 290 of the data processing device 12 in Application Example 1 is realized by the following means.

The present invention provides a server comprising a processor and a communication interface, the processor being configured to receive, via the communication interface, text information from a terminal device; analyze the text information by detecting a length of a character string included in the text information and detecting a number of elements of a list expression included in the text information; acquire reference value information corresponding to the length of the character string and the number of elements of the list expression from a storage device, or set the reference value information based on an analysis result of the text information; compare the analysis result with the reference value information and, when at least one of the length of the character string and the number of elements of the list expression is determined to exceed the reference value information, generate prompt sentence information including instruction content that the text information is to be simplified and main points of the text information are to be extracted, and including the text information; input the prompt sentence information to a generative information processing model and cause the generative information processing model to execute natural language generation processing to generate refinement proposal information of the text information; associate the refinement proposal information with the analysis result to generate response information; and transmit the response information to the terminal device via the communication interface. This enables the server to conditionally and efficiently invoke the generative information processing model based on measured text characteristics, generate machine-oriented prompt sentence information tailored to the analysis result, and return structured refinement proposal information to the terminal device within a predetermined delay time, thereby improving the technical performance of the text-processing system in terms of computational efficiency, response time, and integration between server-side analysis logic and generative AI output.

The term “system” refers to a combination of hardware and software components, including at least one server and at least one terminal device, that cooperatively execute the processing described in the claims.

The term “processor” refers to a hardware computing unit, such as a central processing unit or a processing core, that executes instructions of a program to implement the functions recited in the claims.

The term “terminal device” refers to an information processing device operated by a user, such as a personal computer, a smartphone, or a tablet device, that transmits text information to the server and receives response information.

The term “communication control function” refers to hardware, software, or a combination thereof, that controls data transmission and reception between the server and the terminal device via a communication network using a communication protocol.

The term “text information” refers to data representing one or more characters, symbols, or strings, including natural language sentences and list expressions, input by a user or otherwise provided to the system.

The term “character string” refers to an ordered sequence of characters or symbols included in the text information and processable as a unit by the processor.

The term “list expression” refers to a portion of the text information that represents a list of elements, such as bullet points or numbered items, and that is identifiable based on syntactic patterns or formatting.

The term “number of elements of a list expression” refers to a count of discrete items contained in the list expression, each item being treated as a separate list element by the analysis processing.

The term “length of a character string” refers to a quantitative measure of the character string, such as the number of characters, code points, or units, as calculated by the processor.

The term “analysis result” refers to information obtained by analyzing the text information, including at least the length of the character string and the number of elements of the list expression, and optionally additional derived metrics.

The term “reference value information” refers to threshold data, including one or more numerical values or conditions, used as comparison criteria for evaluating the analysis result of the text information.

The term “storage region” refers to a logical or physical memory area, such as main memory, a storage device, or a database, in which reference value information and other data are stored and from which such data can be read by the processor.

The term “prompt sentence information” refers to data representing a text sequence that includes instruction content for a generative information processing model and the text information, and that is intended to be input to the generative information processing model.

The term “instruction content” refers to a portion of the prompt sentence information that specifies a requested operation or transformation, such as simplifying the text information and extracting main points.

The term “generative information processing model” refers to a machine learning model, such as a generative AI model implementing natural language generation, that receives prompt sentence information as input and outputs generated text.

The term “natural language generation processing” refers to processing performed by the generative information processing model to produce text output in a human-readable natural language based on the prompt sentence information.

The term “refinement proposal information” refers to text data generated by the generative information processing model that represents a modified, simplified, or otherwise improved version of the original text information.

The term “response information” refers to data generated by the processor that includes at least the refinement proposal information and is structured for transmission to the terminal device.

The term “associate” refers to an operation of linking or relating two or more pieces of information, such as associating the refinement proposal information with the analysis result within the response information.

The term “user interface” refers to a set of screens, controls, or interactive elements presented on the terminal device that enables a user to view the refinement proposal information and perform operations in response.

The term “display control function” refers to a software or hardware function of the terminal device that controls rendering and presentation of information, including the refinement proposal information, on a display unit.

The term “adoption operation” refers to a user action, such as selecting or confirming, that indicates acceptance of the refinement proposal information, in whole or in part, as text to be used.

The term “modification operation” refers to a user action, such as editing or partially revising, that indicates alteration of the refinement proposal information or the original text information.

The term “request” refers to data sent from the terminal device to the server that triggers processing including reception of text information, analysis processing, and generation of refinement proposal information.

The term “predetermined delay time” refers to a time constraint set in advance, within which the server is configured to complete at least a sequence of operations from receiving the request to transmitting the refinement proposal information.

The term “real-time properties” refers to characteristics of the system by which the server returns the response information to the terminal device within the predetermined delay time so that the user perceives the system as promptly responsive.

In one embodiment, a server, a terminal, and a network cooperatively implement the invention. The server includes at least one processor, a main memory, a nonvolatile storage device, and a communication interface. The terminal includes a processor, a memory, a display device, and an input device such as a touch panel or keyboard. The server and the terminal are connected via a communication network such as the Internet, using a transport protocol such as TCP/IP and an application protocol such as HTTP or HTTPS.

The server executes an operating system such as a general-purpose server operating system and a runtime environment capable of executing an application program implemented in a high-level language such as Python. The server, in one embodiment, runs a web application framework such as a generic Python-based web framework and uses a database management system such as a relational database for storing configuration information and logs. The server further accesses a generative AI model hosted either on the same physical machine or on a separate inference server via an API. The generative AI model, in one embodiment, is a transformer-based neural network language model trained on large-scale text data, similar in architecture to a large language model.

The terminal executes a web browser application or a native application. The terminal displays an input form for text information, such as a review input field of an electronic commerce application. The user uses the terminal to input text information that may include long sentences and list expressions. The terminal configures an HTTP request that includes the text information as payload data and transmits the request to the server via the communication interface. The terminal, upon reception of response information from the server, parses the response information and displays refinement proposal information and related metrics on the display device. The user interacts with the terminal to adopt, reject, or modify the refinement proposal information.

The server stores program modules in the nonvolatile storage device and loads them into the main memory for execution by the processor. The server includes a reception module, an analysis module, a threshold management module, a prompt generation module, an AI interface module, and a response generation module. The modules are implemented as software components that exchange data through defined data structures in the memory.

The server, using the reception module, receives text information transmitted from the terminal via the communication interface. The server stores the received text information in a buffer region of the main memory as a character string. The server defines an internal data structure for the text information, which may include fields such as a character string field, a language identifier field, and a timestamp field. The reception module appends a record containing the text information to a processing queue in memory.

The server, using the analysis module, processes the text information in the processing queue. The analysis module reads the character string and calculates a length of the character string. In one embodiment, the analysis module counts Unicode code points or character units to determine the length. The analysis module further divides the character string into line units using newline characters and detects list expressions by applying rule-based pattern matching. The analysis module identifies lines starting with symbols such as “-”, “*”, “●” or digit-plus-period patterns such as “1.”, “2.” as list elements. The analysis module uses predetermined regular expressions or string comparison operations to detect these patterns. The analysis module counts the number of list elements, thus obtaining the number of elements of a list expression.

The server stores the analysis result in an analysis record data structure, including at least a field for the length of the character string, a field for the number of list elements, and optional fields such as language type and detected formatting patterns. By structuring the analysis result in this manner, the server can perform later comparison and logging without re-analyzing the text information. This structured analysis reduces redundant computation and contributes to improved processing efficiency.

The server, using the threshold management module, acquires reference value information that defines upper bounds or ranges for the length of the character string and the number of list elements. In one embodiment, the server stores reference value information in the database as configuration entries, such as a maximum character length of 500 units and a maximum number of list elements of 5. The threshold management module reads these values from the database into a configuration cache in memory. In another embodiment, the server dynamically adjusts the reference value information based on past analysis results of many users' texts, so that the thresholds reflect typical usage patterns and desired conciseness levels.

The server, using the analysis module in combination with the threshold management module, compares the analysis result with the reference value information. The server determines whether the length of the character string exceeds the corresponding reference value or whether the number of list elements exceeds the respective reference value. The server sets internal flags in the analysis record, for example a flag indicating that the text is too long or that the text includes too many list elements. When neither metric exceeds its reference value, the server may omit invocation of the generative AI model, thereby reducing computational load and network traffic to the AI inference environment.

The server, using the prompt generation module, generates prompt sentence information when at least one reference value is exceeded. The server constructs the prompt sentence information as a natural language command string. The server inserts instruction content that explicitly describes the desired transformation of the text information, such as simplification and extraction of main points. For example, the server may generate a prompt sentence in the following form:

“Please shorten the following review and focus on the main points: [user's review]”

or

“Rewrite the following product review so that it is shorter, easier to understand, and limited to the most important 3-5 points. Keep the main pros and cons. Review: [user's review]”

The server may also generate a prompt sentence in another language, such as:

“Please shorten the following review and focus on the key points: [User review]”

or

“Please narrow the following bullet points down to 3 to 5 important points: [User bullet points]”

The server, in constructing these prompt sentences, uses predetermined templates and inserts the original text information into designated placeholder positions. The server selects a particular template based on which metric exceeded the threshold and, optionally, based on the language identifier field. The prompt generation module encodes this prompt sentence information as a character string and stores it in a prompt record associated with the analysis record.

The server, using the AI interface module, inputs the prompt sentence information to a generative AI model. In one embodiment, the generative AI model is implemented as a transformer-based neural network that includes an embedding layer, multiple self-attention layers, feedforward layers, and a final projection layer. The model parameters include, for example, several billion weight values. The model is trained on large corpora of natural language texts by minimizing a cross-entropy loss between predicted token distributions and ground truth token sequences. The training uses optimization algorithms such as stochastic gradient descent with adaptive learning rate and techniques such as mini-batch processing, gradient clipping, and regularization.

The server, during inference, encodes the prompt sentence information into token identifiers using a tokenizer. The generative AI model receives the token sequence as input and computes, in each self-attention layer, attention scores over previous tokens using dot products and softmax normalization. The model propagates intermediate representations through the stacked layers, applying non-linear activation functions and normalization at each layer. The final projection layer outputs probability distributions over the vocabulary for each next-token position. The server, using a decoding algorithm such as greedy decoding or beam search, successively selects output tokens to form the refinement proposal information as a natural language character string.

The server, in this embodiment, runs the generative AI model on specialized hardware such as a graphics processing unit or a tensor processing accelerator. This hardware acceleration improves the speed of matrix multiplication operations and reduces latency for each inference request. The AI interface module manages batching of multiple prompt sentence information instances, where feasible, to further improve throughput. By conditionally invoking the generative AI model only when thresholds are exceeded and by using hardware-accelerated inference, the server reduces unnecessary computational load and achieves improved processing speed and scalability.

The server, using the response generation module, associates the refinement proposal information with the corresponding analysis result. The server creates response information that may include fields such as the original character length, the number of list elements, one or more flags indicating threshold violations, and the refinement proposal information as generated text. The server transmits the response information to the terminal via the communication interface. The structured format of the response information allows the terminal to directly display not only the refinement proposal but also quantitative indicators of why the proposal was generated, improving user transparency and reducing the need for additional client-side computation.

The terminal, upon receiving the response information, generates a user interface on the display device. The terminal presents the refinement proposal information and, optionally, the original text information in separate sections or in a toggleable view. The terminal displays buttons or icons to allow the user to perform an adoption operation, in which the refinement proposal information replaces or is inserted into the input field, and a modification operation, in which the user edits the refinement proposal information before final submission. The terminal, by offloading the main analysis and AI processing to the server, can run on devices with limited local resources while still providing high-quality refinement support.

The server, by structuring the entire pipeline so that reception, analysis, threshold comparison, prompt generation, AI inference, and response transmission are executed within a predetermined delay time, achieves real-time properties from the user's perspective. For example, in one embodiment, the server targets a round-trip delay of less than one second for average-length text and less than several seconds for longer text. The server monitors processing times of each module and may adapt internal parameters, such as limiting maximum text length for AI processing, to maintain a consistent response time. This control of latency improves the technical performance of the system compared to naive integration where all texts are always sent to the generative AI model regardless of length or structure. The system improves computer technology in multiple respects. First, by analyzing specific metrics (character-string length and number of list elements) on the server side and using those metrics to gate AI invocation, the system reduces unnecessary network calls and inference operations. This reduction results in lower CPU and accelerator utilization, less memory pressure, and reduced energy consumption on the server infrastructure. Second, by defining structured prompt sentence information that includes explicit instruction content and original text information, the system improves the quality and consistency of AI outputs, which in turn reduces the number of retries or additional refinement calls needed. Third, by returning structured response information that includes both analysis results and refinement proposals, the system simplifies the processing required on the terminal and ensures that user interfaces can be generated with minimal local computation.

The generative AI model operates according to rules and procedures that differ from manual human editing. The model applies learned statistical relationships between tokens and higher-level semantic patterns derived from large-scale training data; it does not simply follow fixed human-written grammar rules or manual editing heuristics. The server leverages this non-human, model-based inference by encoding user instructions and text characteristics in the prompt sentence information in a way that aligns with the internal representation space of the model. As a result, the model tends to produce concise and coherent refinements in fewer iterations than a rule-based or human-edited system, thereby improving computational efficiency and output consistency.

In another embodiment, the server uses alternative generative AI configurations. The server may employ an encoder-decoder neural network architecture where the encoder processes the prompt sentence information into a latent representation, and the decoder generates the refinement proposal information from this representation. The server may incorporate additional features into the prompt sentence information, such as numeric indicators of text length or list count, to give the model a more precise target for condensation. The model may be fine-tuned on a corpus of original and improved reviews using supervised learning with a loss function that penalizes overly long outputs or loss of key points.

The server may also employ data augmentation techniques during model training, such as randomly masking parts of reviews, shuffling list elements within constraints, or injecting synthetic noise, to improve robustness of the generative AI model to diverse input styles. The training process updates weight parameters using backpropagation and gradient-based optimization, where the error function considers both semantic similarity to target texts and compactness of the produced text. By designing the model training with these criteria, the system achieves higher accuracy in capturing main points while shortening text, which translates into more effective refinement proposals at runtime.

In yet another embodiment, the server adjusts threshold values dynamically based on system load or user category. For example, when the server detects heavy load, the server may temporarily increase the minimum length required to trigger AI refinement, thereby reducing the number of AI calls and balancing resource usage. Conversely, for users who opt in to more aggressive rewriting assistance, the server may lower thresholds. This adaptive control of thresholds and AI invocation provides a technical mechanism for managing computation and communication resources in real time.

The terminal, in a further variation, may cache refinement proposal information locally when network connectivity is intermittent. The terminal may store the last few proposals in local storage and provide offline access to those proposals. When connectivity is restored, the terminal may synchronize pending user actions with the server. This variation highlights that the invention can be realized in environments with variable network conditions and that the structured response information format supports flexible client-side implementations. Through these embodiments and variations, the server, the terminal, and the generative AI model cooperate via defined data structures, analysis algorithms, and prompt sentence construction rules to provide a technically improved text-processing system. The system does not merely automate human mental editing; rather, it restructures the flow of data and the use of AI inference in a way that reduces server resource usage, improves response time, enhances the quality and consistency of generated text, and integrates analysis and generation in a manner that is specific to the computing architecture and not conventionally performed by human editors.

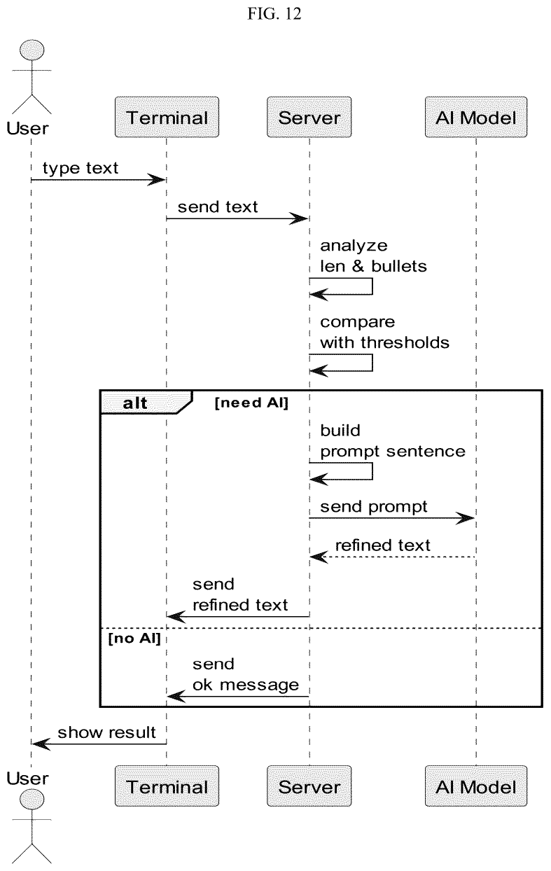

The following describes the processing flow using FIG. 12.

### Step 1:

The user operates the terminal to input text information. The terminal displays an input area on a screen and accepts key operations or touch operations from the user to generate a character string. The terminal sets the input character string and associated metadata (such as language and timestamp) as input and constructs an internal data structure representing the text information. The terminal, based on this input, generates a request message by encoding the text information into a payload and prepares to transmit it to the server as output.

### Step 2:

The terminal transmits the request message to the server. The terminal uses a communication module to encapsulate the text information into a network packet and sends the packet to a predetermined server address using a network protocol. The input of this step is the internal data structure containing the text information, and the output is a formatted network request, including headers and body, that is delivered to the server.

### Step 3:

The server receives the request message from the terminal. The server uses a communication interface to parse network headers and extract the payload containing the text information. The input of this step is the network request received over the communication channel, and the output is a text information object stored in main memory, including fields for the original character string and optional identifiers such as a session ID or user ID. The server writes this text information object into a processing queue or buffer region as part of its concrete operation.

### Step 4:

The server analyzes the text information to calculate a length of a character string. The server takes the text information object as input, reads the character string field, and counts the number of characters or code points using string-processing functions. The server performs data operations such as iterating over the character sequence and incrementing a counter for each character. The output of this step is a numeric length value stored in an analysis record associated with the text information.

### Step 5:

The server analyzes the text information to detect and count elements of a list expression. The server uses the same text information object as input and splits the character string into multiple line segments by detecting newline characters. The server examines each line segment and applies pattern-matching rules, such as checking whether a line starts with a symbol “-”, “*”, “●” or a digit followed by a period and a space. For each line that matches a list pattern, the server increments a list element counter. The output of this step is a numeric count of list elements, which the server stores in the analysis record together with the character-string length.

### Step 6:

The server acquires reference value information for the character-string length and the number of list elements. The server uses the analysis record as input to determine which reference values to retrieve and reads configuration entries from a storage device or in-memory cache. The server loads values such as a maximum allowable character length and a maximum allowable number of list elements. The data processing in this step includes retrieving and mapping configuration keys to corresponding numeric values. The output is a threshold information object containing at least two reference values, which the server associates with the analysis record.

### Step 7:

The server compares the analysis result with the reference value information. The server uses the analysis record (containing the measured length and list count) and the threshold information object as input. The server performs comparison operations such as evaluating whether the measured length is greater than the maximum allowable length and whether the measured list count is greater than the maximum allowable list count. Based on these evaluations, the server sets one or more flags, such as a “too_long” flag or a “too_many_lists” flag, in the analysis record. The output of this step is an updated analysis record that includes both original metrics and determination flags.

### Step 8:

The server determines whether to invoke a generative AI model based on the determination flags. The server reads the updated analysis record as input and checks the status of the flags. If neither metric exceeds its corresponding reference value, the server decides not to generate prompt sentence information and not to call the generative AI model. If at least one flag is active, the server decides to generate prompt sentence information. The data processing includes a logical evaluation of the flags and branching of the processing flow. The output is a decision indicator specifying whether AI-based refinement is required.

### Step 9:

The server generates prompt sentence information when AI-based refinement is required. The server uses the original text information and the decision indicator as input. The server selects a prompt template based on which thresholds were exceeded and possibly based on the language of the text. The server performs string concatenation and placeholder substitution to construct a prompt sentence that includes instruction content and the original text. The server, for example, creates one of the following prompt sentences as output:

“Please shorten the following review and focus on the main points: [user's review]” “Rewrite the following product review so that it is shorter, easier to understand, and limited to the most important 3-5 points. Keep the main pros and cons. Review: [user's review]” “Please shorten the following review and focus on the key points: [User review] “Please narrow the following bullet points down to 3 to 5 important points: [User bullet points]”

The output of this step is a prompt sentence object that encapsulates the generated prompt as a character string.

### Step 10:

The server encodes the prompt sentence and sends it to a generative AI model. The server uses the prompt sentence object as input and converts the character string into a token sequence using a tokenizer associated with the generative AI model. The server constructs an API request that includes the token sequence and model parameters such as maximum output length and randomness control values. The server transmits this request to an inference engine implementing the generative AI model. The data processing includes text-to-token transformation and formation of a structured request message. The output of this step is an inference request issued to the generative AI model.

### Step 11:

The server receives an output sequence from the generative AI model and reconstructs refinement proposal information. The server uses the inference response as input, which contains a sequence of token identifiers representing the generated text. The server applies a detokenization process to map token identifiers back to human-readable characters and reconstructs a character string. The server may perform normalization operations such as trimming excessive whitespace or normalizing line breaks. The output of this step is refinement proposal information stored as a character string in a refinement record linked to the analysis record.

### Step 12:

The server generates response information that associates the refinement proposal information with the analysis result. The server uses the analysis record and the refinement record as input. The server constructs a structured data object that includes fields for the original length, the list count, the determination flags, and the refinement proposal text. The server may include additional fields indicating which thresholds were exceeded. The data processing includes assembling these fields into a unified response structure. The output of this step is response information ready for transmission to the terminal.

### Step 13:

The server transmits the response information to the terminal. The server uses the response information as input to a communication module that formats the data into a response message, including necessary protocol headers and a body. The server sends this response message over the network to the terminal address associated with the original request. The output of this step is a network response carrying the refinement proposal information and analysis results toward the terminal.

### Step 14:

The terminal receives the response information and updates the user interface. The terminal uses the network response as input and parses the contained response information to obtain the refinement proposal text and analysis metrics. The terminal then generates or updates visual components on the display, such as text areas, labels, and action buttons. The data processing includes mapping response fields to display elements and updating internal state that represents the current proposal. The output of this step is a refreshed user interface that presents the refinement proposal information to the user.

### Step 15:

The user interacts with the terminal to adopt or modify the refinement proposal information. The user uses input operations such as tapping buttons or editing text fields as input to the terminal. The terminal processes these operations, for example by copying the refinement proposal text into an editable input area when the user chooses adoption, or by allowing direct editing of the refinement text when the user chooses modification. The output of this step is an updated text content on the terminal that reflects the user's decision, which may then be committed as final text and optionally sent to a separate server-side storage system.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

In text-based communication environments, such as messaging platforms, document editors, and social networking services, computer systems are increasingly used to assist users in drafting and revising textual content. Conventional systems that provide writing assistance frequently rely on static rule-based checks or on direct, unstructured calls to generative AI models. Such approaches suffer from several technical drawbacks in terms of computer technology.

First, conventional systems typically transmit the entire user text to an external generative AI model without any adaptive pre-analysis on a local processor. As a result, the system consumes excessive network bandwidth and remote computation resources, even for short or simple texts that may not require sophisticated revision. This lack of adaptive control increases latency, server load, and operating cost, and may limit scalability when a large number of requests are processed concurrently.

Second, conventional systems often do not perform structured analysis of text structure information, such as character count and number of bullet points, on the local processor prior to invoking the external generative AI model. Without such analysis, the system cannot compute meaningful evaluation indices that reflect the complexity or type of the text, and therefore cannot set dynamic thresholds or generation conditions. This leads to inefficient triggering of model calls and suboptimal use of computational resources, degrading overall system performance.

Third, conventional systems generally generate simple, generic prompts for the generative AI model, independent of user attributes, language type, or expression style of the text data. Because the prompt is not tailored to the user-specific or document-specific context, the model may produce revision proposals that are overly broad, inconsistent in tone, or misaligned with the intended style. This lack of context-aware prompt generation reduces the effectiveness of the assistance and can require additional manual corrections by the user. Fourth, conventional systems often return raw model output directly to the user interface, without reconstructing or formatting the revision proposal in accordance with notification conditions and delivery media. As a consequence, the information presented to the user may be poorly structured, difficult to navigate, or not optimized for delivery through particular electronic communication services or information delivery services. This undermines the usability of the system and increases the cognitive load on the user when trying to understand and apply the suggestions.

Therefore, there is a need for a computer-implemented system that improves the technical operation of text revision assistance by: (i) locally analyzing text structure information to derive evaluation indices and dynamically control when and how a generative AI model is invoked; (ii) generating structured, context-aware prompt sentences that instruct the external model in a more precise manner; and (iii) reconstructing and formatting the revision proposals into notification message data tailored to specific communication channels and user conditions. Such a system would improve the efficiency, scalability, and responsiveness of the underlying computer infrastructure, while delivering more relevant and usable revision assistance to the user.

The specific processing by the specific processing unit 290 of the data processing device 12 in Example 2 is realized by the following means.

The present invention provides a server comprising a processor configured to receive text data from a terminal via a communication path; analyze the received text data to calculate evaluation indices including at least character count and a number of bullet points as text structure information; dynamically set threshold information including generation conditions based on the evaluation indices; generate, when the set threshold information satisfies a predetermined condition, a prompt sentence that includes at least a part of the text data and instructs analysis and creation of a revision proposal regarding grammar, writing style, and content coherence; transmit the prompt sentence, via a communication protocol, to a generation computation unit included in an external generative AI model and receive revision proposal data generated by the generative AI model; reconstruct the received revision proposal data in accordance with notification conditions and provision media for each user and format the reconstruction as notification message data; and transmit the notification message data to the terminal via an electronic communication service or an information delivery service. This enables adaptive and resource-efficient invocation of the external generative AI model based on locally computed evaluation indices, context-aware generation of prompt sentences tailored to user attributes and text characteristics, and structured delivery of revision proposals optimized for specific communication channels, thereby improving the performance, scalability, and usability of computer-based text revision assistance.

The term “text data” refers to character-based information representing user-authored content, such as sentences, paragraphs, or lists, which is processable by a computing device.

The term “terminal” refers to an information processing apparatus, such as a client device, including at least one input interface, output interface, communication interface, and processor, configured to transmit and receive data via a communication path.

The term “communication path” refers to a logical or physical connection that enables data transmission between devices, including wired networks, wireless networks, and the Internet, using one or more communication protocols.

The term “processor” refers to one or more hardware processing units, such as a central processing unit or an execution core, configured to execute instructions and perform arithmetic and logical operations on data.

The term “evaluation indices” refers to one or more quantitative or qualitative metrics computed from text data, including at least a character count and a number of bullet points, and optionally including additional structural or linguistic measures.

The term “text structure information” refers to information indicating structural aspects of the text data, including but not limited to character count, number of bullet points, sentence count, paragraph count, and presence of list structures.

The term “threshold information” refers to one or more criterion values or conditions that are set based on evaluation indices and used to determine whether and how subsequent processing by a generative AI model is to be performed.

The term “generation conditions” refers to parameters or rules, included in the threshold information, that specify circumstances for invoking a generative AI model, such as minimum text length, complexity level, or required analysis type.

The term “prompt sentence” refers to a text string that includes at least a part of the text data and one or more instructions, and that is provided as input to a generative AI model to control the content, style, or scope of a generated output.

The term “revision proposal” refers to information indicating one or more suggested modifications to the text data, including corrections, improvements, or alternative expressions relating to grammar, writing style, and content coherence.

The term “grammar” refers to structural rules governing the composition of clauses, phrases, and words in a particular language, including syntax, morphology, and agreement.

The term “writing style” refers to characteristics of expression in text, including tone, formality, word choice, and sentence structure, which influence readability and perceived style of the content.

The term “content coherence” refers to a degree of logical consistency and clarity in the text data, including appropriate flow of ideas, connection between sentences, and alignment with the intended topic.

The term “generative AI model” refers to a machine-implemented model, such as a neural network-based language model, configured to generate output text based on input text, including a prompt sentence, by performing probabilistic or learned transformations.

The term “generation computation unit” refers to a hardware and software combination, associated with the generative AI model, that executes computations for generating output text in response to input text.

The term “communication protocol” refers to a set of rules and formats used to control the exchange of data between devices or services, including, for example, transport protocols and application-layer protocols.

The term “revision proposal data” refers to digital data representing a revision proposal that has been generated by the generative AI model in response to a prompt sentence.

The term “notification conditions” refers to one or more rules or settings associated with a user that determine how, when, or through which channel revision proposal data is to be transmitted.

The term “provision media” refers to types or formats of output channels through which information is provided to a user, including screen displays, email messages, and messages in communication applications.

The term “notification message data” refers to digital data constituting a message that includes at least part of the revision proposal data and is formatted for delivery to a terminal according to notification conditions and provision media.

The term “electronic communication service” refers to a service that enables electronic messaging between devices or users, including email services and messaging services provided over communication networks.

The term “information delivery service” refers to a service configured to deliver information to users via one or more channels, such as push notification services, social networking services, or content distribution platforms.

The term “user attribute information” refers to information associated with a user, including preferences, proficiency level, language preference, or profile data, that can influence processing or output generation.

The term “designation information” refers to information explicitly specified by a user or system, indicating desired characteristics such as language type, expression style, or revision policy for processing the text data.

The term “language type” refers to a classification of text according to a natural language, such as English, Japanese, or other human languages.

The term “expression style” refers to a stylistic mode of text expression, such as formal, informal, technical, academic, or conversational style.

In one embodiment, a server, a terminal, and a networked external computing environment cooperate to implement the claimed system. The server implements the processor recited in the claims. The terminal operates as a client device and includes at least one input interface such as a keyboard or a touch panel, at least one display, a communication interface conforming to network standards such as IEEE 802.11 or cellular standards, and a local processor executing client software such as a web browser or a native application. The server includes at least one central processing unit, a main memory, a non-volatile storage device such as a solid-state drive, a network interface controller, and an operating system such as a general-purpose server operating system. The server executes server-side software such as a web server, an application server, and an API client module.

The server stores a program in the non-volatile storage device. The server loads the program into the main memory and executes the program on the central processing unit. The program defines a set of data structures including, for example, a text data buffer for storing user-submitted text data, an evaluation index record for storing character count and bullet point count, a threshold information record for storing dynamically set generation conditions, a prompt sentence buffer for storing a prompt sentence to be submitted to a generative AI model, and a notification message record for storing reconstructed revision proposal data for transmission to the terminal.

The terminal transmits text data to the server via a communication path such as the Internet using a secure communication protocol such as HTTPS. The terminal displays a text input field to the user by executing client-side code delivered from the server. The user operates the terminal to input one or more sentences, paragraphs, or lists into the text input field. The terminal packages the input as text data and transmits the text data to the server in a request message.

The server receives the text data via the network interface and stores the text data in the text data buffer. The server executes a text analysis module on the central processing unit. The server parses the text data to compute evaluation indices including at least a character count and a number of bullet points. The server uses simple but explicit algorithms to compute these indices. For example, the server counts the number of characters by iterating over the code points in the text data buffer and incrementing a character counter for each valid character. The server counts the number of bullet points by scanning for predefined bullet symbols or patterns such as “-”, “*”, or numbered list patterns and incrementing a bullet counter each time such a pattern is detected. The server writes the resulting counts into the evaluation index record in the main memory.

The server uses the evaluation indices to dynamically set threshold information. The server stores threshold information in the threshold information record as structured data, such as fields indicating minimum character count, maximum character count, minimum bullet count, and flags indicating whether to request detailed analysis from a generative AI model. The server updates these fields using predetermined rules or functions that map evaluation indices to generation conditions. For example, the server sets a flag to request detailed coherence analysis when the character count exceeds a first threshold and the number of bullet points exceeds a second threshold. The server thereby adapts the decision to invoke the generative AI model based on local quantitative analysis rather than sending all text indiscriminately.

The server generates a prompt sentence when the threshold information satisfies a predetermined condition. The server uses a prompt generation module that accesses the text data buffer, the evaluation index record, and user-related information such as user attribute information and designation information (for example, language type and expression style).

The server selects a prompt template based on the language type and expression style. For example, the server uses a general English improvement template, a Japanese proofreading template, or an academic writing template. The server then inserts at least part of the text data into the chosen template and, where appropriate, inserts meta-information such as desired strictness of grammar correction or preferred tone based on user attribute information.

The server generates the prompt sentence as plain text in the prompt sentence buffer. In one example, the server generates a prompt sentence in English of the form:
“Please evaluate the following text and suggest improvements to grammar, style, and coherence. First list specific issues, then provide a revised version. Text: “[user text]”” In another example, the server generates a prompt sentence for Japanese proofreading:
“Please proofread the following Japanese sentence. Point out issues in grammar, word choice, and clarity, then propose an improved sentence. Sentence: [[user text]]” In another example, the server generates a prompt sentence for academic style:
“Rewrite the following text in a more formal and academic style while improving grammar and logical flow. After the rewritten text, list the main changes you made. Text: “[user text]”” The server tailors these prompt sentences by inserting the actual text data and by adjusting instructions based on the evaluation indices and the user attribute information. For instance, when the evaluation indices indicate a large number of bullet points, the server explicitly instructs the generative AI model to maintain list structure.

The server then transmits the prompt sentence to an external generative AI model via a communication protocol such as HTTPS. The external generative AI model resides on a remote computing environment that includes a plurality of processing accelerators such as graphics processing units or tensor processing units. The generative AI model can be implemented as a large-scale neural network-based language model, for example a transformer-based architecture with multiple self-attention layers, feed-forward layers, and layer normalization. The generative AI model is configured with parameters including token embedding matrices, positional encoding parameters, and weight matrices for attention heads and feed-forward layers.

The generative AI model is trained in advance using supervised learning and unsupervised learning on large corpora of natural language text. During training, the generative AI model minimizes an error function such as cross-entropy loss between predicted tokens and ground-truth tokens using an optimization algorithm such as stochastic gradient descent with adaptive moment estimation. The generative AI model updates its weight parameters by computing gradients via backpropagation and adjusting the weights according to learning rates. Data augmentation techniques such as random masking, shuffling, or noise injection may be used during training to improve generalization. As a result, the generative AI model learns language patterns that enable it to predict likely continuations and generate coherent text based on an input prompt sentence.

In operation, the server encodes the prompt sentence into a request message that conforms to an application programming interface specification of the generative AI model. The server transmits the request message through the network interface to the remote environment. The generative AI model tokenizes the prompt sentence into a sequence of tokens using a vocabulary defined at training time. The generative AI model maps tokens to embeddings and propagates them through the transformer layers. The model computes attention scores between tokens, applies non-linear transformations, and outputs a sequence of tokens that constitutes a revision proposal. The model's internal computation is controlled by hyperparameters such as the number of layers, hidden dimension size, and number of attention heads. The generative AI model uses generation parameters such as temperature, top-k sampling, or nucleus sampling to control diversity and determinism of the generated text.

The server receives the revision proposal data from the generative AI model as text in a response message. The server stores the revision proposal data in the main memory. The server then reconstructs the revision proposal data to form notification message data according to notification conditions and provision media for each user. The server accesses user attribute information and provision media settings from a configuration store such as a database. For example, the server retrieves whether the user has selected email, messaging application, or in-app display as the delivery channel, and whether the user prefers a compact summary or a detailed explanation.

The server restructures the revision proposal data by parsing sections such as issue lists and revised versions. The server may search for textual markers or bullet symbols in the revision proposal data and split the data into structured segments. The server formats these segments into notification message data that is suitable for the selected channel. For an email channel, the server may generate clear headings such as “Original Text,” “Detected Issues,” and “Suggested Revision,” and insert line breaks to enhance readability. For a messaging application, the server may generate a shorter summary and a link or identifier to access the full suggestions. The server writes the resulting notification message data into the notification message record.

The server then transmits the notification message data via an electronic communication service or an information delivery service to the terminal. The server uses communication protocols such as SMTP for email transmission or platform-specific APIs for messaging services. The terminal receives the notification, displays it to the user on the display, and allows the user to read and apply the suggestions. The user can revise the original text on the terminal and optionally resubmit the revised text, causing the server to repeat the analysis and generation process, thereby iteratively improving the text.

The described configuration provides technical improvements to computer technology. The server reduces unnecessary network traffic and remote computation by dynamically determining, based on locally computed evaluation indices, whether and how to invoke the generative AI model. The server thereby avoids transmitting short or simple texts for full analysis when such analysis is not necessary, reducing communication load and latency. The server also adapts prompt sentences to text structure and user attributes, resulting in outputs that require fewer iterations and less post-processing. This reduces the total number of requests and improves overall throughput.

The server improves computational efficiency by performing lightweight, structured pre-analysis (character counting, bullet detection, and other text structure computations) on the local processor using simple integer operations, which are less resource-intensive than remote inference on the generative AI model. By gating the expensive remote inference with local thresholds, the server effectively implements a hierarchical processing architecture where low-cost local processing filters inputs and reserves high-cost model calls for complex cases. This architecture reduces average processing time per request and allows the system to scale to more users with the same hardware resources.

The server improves data management by maintaining explicit data structures for evaluation indices, threshold information, prompt sentences, and notification messages. These data structures allow deterministic and traceable decisions about when the generative AI model is invoked, what instructions are sent, and how outputs are reconstructed. This is different from conventional direct model invocation, where the same unstructured prompt is used for all cases. The explicit control data enables the server to tune behavior for different workload patterns, which leads to predictable performance and resource usage.

The server improves accuracy and usefulness of revision proposals by generating prompt sentences that encode user-specific and document-specific constraints. For example, the server can instruct the generative AI model to preserve bullet structure, maintain a formal tone, or emphasize coherence improvements over stylistic changes. These instructions guide the generative AI model to allocate its internal attention and generation capacity along dimensions that are more relevant to the user's needs. As a result, the generative AI model produces more targeted suggestions, which reduces the need for repeated queries and manual corrections.

The system uses AI processing in a manner that differs from simple automation of human editing. The server does not merely ask the generative AI model to “correct” text in an abstract way. Instead, the server computes quantitative evaluation indices, derives threshold information, constructs structured prompt sentences according to non-conventional rules, and integrates these steps into a layered processing pipeline. The server thereby creates a non-human, machine-only procedure that optimizes the usage of computing resources and network bandwidth. A human editor would not typically compute detailed character counts and bullet counts to decide whether to consult another human; however, the server uses such metrics as explicit control inputs to the generative AI model invocation.

In another embodiment, the server extends the evaluation indices to include additional features such as sentence count, average sentence length, and a simple lexical diversity metric. The server can compute sentence count by detecting sentence delimiters, compute average sentence length by dividing character count by sentence count, and compute lexical diversity by counting distinct tokens. The server can then update the threshold information to control not only whether to invoke the generative AI model but also which analysis modes to request in the prompt sentence. For example, when average sentence length exceeds a threshold, the prompt sentence can explicitly request segmentation of long sentences.

In another embodiment, the server selects among multiple generative AI models or model configurations based on evaluation indices. For short texts, the server may select a smaller generative AI model running on a less powerful accelerator, and for long texts, the server may select a larger model with deeper layers for better context handling. The server describes this selection in internal control data and includes identification of the chosen configuration in the request message. This model selection further optimizes resource utilization and latency.

In another embodiment, the server may update prompt templates over time based on feedback signals such as user acceptance of suggestions or correction rates. The server may compute additional indices such as how often users apply suggested changes. The server can utilize these indices to adjust threshold information and prompt sentence patterns, e.g., by declining to request style changes when users consistently discard them. This feedback-driven adaptation further improves accuracy and efficiency.

The described embodiments are not limited to any particular hardware or software platform. The server can be implemented on a variety of server hardware, including on-premises servers or cloud-based instances. The generative AI model can be implemented on various accelerator architectures and neural network frameworks. The terminal can be any device capable of data input and network communication. Variations in specific implementations, such as using different programming languages, data serialization formats, or model architectures, fall within the scope of the described system as long as the system includes the processor operations defined in the claims, including the local computation of evaluation indices, the dynamic setting of threshold information, the generation of prompt sentences, the interaction with a generative AI model, and the reconstruction and transmission of notification message data.

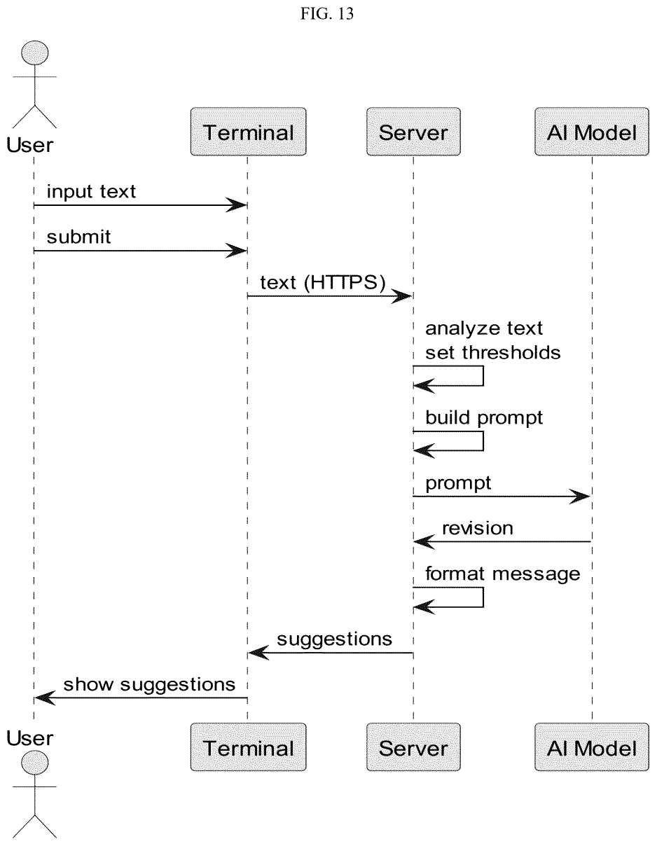

The following describes the processing flow using FIG. 13.

### Step 1:

The user operates the terminal to launch a client application or web browser and open a text input screen.

The terminal receives user keystrokes as input and stores the characters temporarily in local memory as text data.

The terminal displays the entered characters on the screen in real time so that the user can confirm the content visually.

### Step 2:

The user operates the terminal to finalize the text and initiate transmission, for example by pressing a “Submit” button.

The terminal takes the current text data as input and constructs a request payload, for example creating a data structure containing at least a text field and optional settings fields.

The terminal outputs an HTTP or HTTPS request containing the payload addressed to the server's application endpoint.

### Step 3:

The terminal uses its communication interface to establish a secure connection to the server over a network.

The terminal inputs the destination address, protocol parameters, and the request payload into a network stack, which performs encryption and packetization.

The terminal outputs encrypted data packets representing the text submission to the server via the communication path.

### Step 4:

The server uses a network interface to receive the encrypted packets as input from the communication path.

The server terminates the secure session, decodes the packets, and reconstructs the original HTTP or HTTPS request message.

The server parses the request message and outputs the extracted text data and associated metadata to an application layer module.

### Step 5:

The server receives the text data and metadata as input and stores them in a text data buffer in main memory.

The server normalizes the text data by converting character encoding to a standard form, unifying line breaks, and optionally removing control characters, which constitutes a series of string manipulation operations.

The server outputs normalized text data ready for analysis and stores a reference to this data in an internal data structure.

### Step 6:

The server inputs the normalized text data into a text analysis module executed on the processor.

The server iterates through each character in the text, increments a character counter when a valid character code is detected, and stores the final count as a character count evaluation index.

The server scans the text for predefined bullet patterns (for example “-” or numbered list prefixes), increments a bullet counter for each match, and outputs an evaluation index record containing at least the character count and bullet count.

### Step 7:

The server uses the evaluation index record as input to a threshold computation module.

The server applies predetermined rules or functions, such as comparing the character count against a minimum length threshold and the bullet count against a structure threshold, to compute threshold information.

The server outputs threshold information that includes generation conditions, such as flags indicating whether to request detailed analysis, required analysis types, or recommended model complexity.

### Step 8:

The server evaluates the threshold information as input to decide whether to invoke a generative AI model and what kind of prompt sentence to generate.

The server checks, for example, whether the character count exceeds a first threshold and whether the bullet count exceeds a second threshold; if the conditions are not satisfied, the server may output a decision to skip external model invocation and instead output a simple local suggestion.

If the conditions are satisfied, the server outputs a decision to generate a full prompt sentence and proceed with external model processing.

### Step 9:

The server inputs the normalized text data, the evaluation indices, and user-related settings such as language type and expression style into a prompt generation module.

The server selects an appropriate template based on the language and style and then performs string concatenation and insertion operations to embed at least part of the text data and specific instructions into the template.

The server outputs a completed prompt sentence and stores it in a prompt sentence buffer.

### Step 10:

The server formats the prompt sentence as input to a request message for the external generative AI model.

The server constructs a data structure including at least an identifier of the selected generative AI model, generation parameters, and the prompt sentence, and then serializes this data structure into a protocol-compliant request format.

The server outputs a model request message ready for transmission over a communication protocol such as HTTPS.

### Step 11:

The server uses its network interface to transmit the model request message as input to a remote computing environment that hosts the generative AI model.

The server invokes a network library that splits the request into packets, encrypts the payload, and sends the packets over the network to the model endpoint address.

The server outputs network traffic that represents the prompt sentence and control parameters to the generative AI model infrastructure.

### Step 12:

The generative AI model, executed on remote hardware, receives the prompt sentence as input and performs tokenization, embedding lookup, and neural network inference operations to generate a revision proposal.

The model processes the token sequence through multiple attention and feed-forward layers and computes probabilities for output tokens, thereby generating textual content that constitutes a revision proposal including suggested corrections and improved wording.

The remote environment outputs the generated revision proposal data in a response message and sends it back to the server via the network.

### Step 13:

The server receives the response message as input through the network interface.

The server decodes and verifies the response, parses the serialized structure, and extracts the generated revision proposal text from the payload.

The server outputs a revision proposal data object containing the model-generated suggestions and stores it in main memory.

### Step 14:

The server inputs the revision proposal data and the original text data into a reconstruction module.

The server analyzes the structure of the revision proposal, for example by identifying headings, issue lists, and revised versions using pattern matching and text segmentation operations.

The server outputs a set of structured segments representing at least the original text, a list of detected issues derived from the evaluation indices, and the revised text suggested by the generative AI model.

### Step 15:

The server uses the structured segments and user-specific notification conditions as input to a formatting module.

The server selects a formatting style based on the target provision media, such as email or messaging application, and then arranges the segments into a notification message body with appropriate headings, line breaks, and emphasis markers.

The server outputs notification message data formatted for the selected communication channel and stores it in an internal message record.

### Step 16:

The server inputs the notification message data and user contact information into a transmission module.

For email, the server establishes a connection with an email delivery service using a mail transfer protocol, composes an email with a subject line and body, and injects the message into the mail delivery system; for a messaging service, the server constructs an API request including the message body and recipient identifier.

The server outputs the notification message over the corresponding electronic communication service or information delivery service toward the terminal.

### Step 17:

The terminal receives the notification message as input from the electronic communication service or information delivery service.

The terminal decodes the message, stores it in a local message store, and updates its display to indicate that a new message is available.

The terminal outputs a rendered view of the notification message on the screen when the user opens the corresponding email or messaging application.

### Step 18:

The user operates the terminal to open and read the notification message.

The terminal presents the original text, the list of detected issues, and the revised proposal to the user as output.

The user uses this information as input to a new editing session, modifies the original text on the terminal according to the suggestions, and may resubmit the revised text, which causes the server to repeat the analysis and generation operations.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional text-assistance systems that rely on generative AI models generally treat user input as a simple sequence of characters and directly pass such input to a generative model with a static prompt. As a result, these systems suffer from several technical limitations.

First, the processor typically does not perform structured analysis of text information (for example, detection of character amount or enumeration amount) in a manner that systematically controls when and how a generative AI model is invoked. Without such structural metrics and threshold-based control, the processor may request generation from the generative AI model even for short or simple texts for which revision is unnecessary, thereby increasing computational load, network traffic, and latency in a non-optimized manner. This leads to inefficient use of hardware resources and degraded responsiveness of the overall computing environment.

Second, conventional systems generally fail to integrate emotion analysis information into the control logic of generative AI models in a structured way. While some systems may perform sentiment analysis, they typically do not use emotion evaluation information of both a transmission subject and one or more reception subjects to adjust a tone of modification candidate information. As a consequence, generated revision proposals can be misaligned with user-specific emotional context, which can cause increased user corrections, repeated model calls, and feedback loops that further burden the processor and communication modules. The lack of a systematic tone adjustment mechanism based on multi-party emotion evaluation prevents the processor from efficiently generating context-appropriate text revisions.

Third, known systems do not generally maintain and exploit structured record information that combines: (i) prompt sentence generation conditions, (ii) structural metrics and thresholds, (iii) emotion evaluation information, and (iv) user interaction outcomes such as adoption or rejection of generated modifications. Without this persistent record information, the processor cannot perform effective learning control to refine reference values or prompt generation logic over time. As a result, the system is unable to reduce unnecessary model invocations, cannot optimize prompts for improved output quality or reduced token usage, and cannot systematically adapt to user behavior. This leads to persistent inefficiencies in computational processing, bandwidth usage, and storage operations.

Fourth, when multiple reception subjects are involved (for example, in group communication), conventional systems typically generate a single, static suggestion for the transmission subject only, and do not treat collective emotion evaluation information as a first-class control signal. They do not allow the processor to dynamically decide whether to generate common modification candidate information or individualized modification candidate information per reception subject. This absence of collective emotion-based control prevents the system from efficiently managing multi-user notification paths and often results in repeated, redundant generative AI operations for similar contexts.

Accordingly, there is a need for a computer-implemented system and method in which a processor: (i) performs explicit structural analysis of text information and threshold-based control before invoking a generative AI model; (ii) integrates multi-party emotion evaluation into tone adjustment of modification candidate information; (iii) records combined metrics, prompts, and user outcomes to drive learning control of reference values and prompt conditions; and (iv) utilizes collective emotion evaluation in multi-user scenarios to generate and distribute modification candidate information in a more resource-efficient and context-appropriate manner. Such a system improves the functioning of the computer itself by optimizing when and how generative AI resources are used, by reducing unnecessary processing, and by improving the quality and relevance of generated outputs with respect to both structural and emotional context.

The specific processing by the specific processing unit 290 of the data processing device 12 in Application Example 2 is realized by the following means.

The present invention provides a server comprising a processor configured to receive text information, analyze a structure of the text information to detect at least an amount of characters and an amount of enumeration information, set a reference value based on the detected amounts, determine, for text information exceeding the reference value, whether to request generation of modification candidate information, generate a prompt sentence including content of modification candidate generation, a target range, and an adjustment policy based on a determination result and the text information, input the prompt sentence into a generative information processing model to cause the generative information processing model to generate the modification candidate information, execute emotion analysis processing on at least the text information to obtain emotion evaluation information representing emotion states of at least a transmission subject and at least one reception subject, modify the modification candidate information so as to perform tone adjustment based on the emotion evaluation information, store the modification candidate information, tone adjustment results, and associated analysis information as record information, perform learning control to update at least the reference value and a generation condition of the prompt sentence based on the record information, and execute communication processing to distribute the modification candidate information to at least one reception subject. This enables structural and emotional context to be leveraged by the processor to selectively invoke the generative information processing model, to adapt prompt sentences and thresholds over time based on recorded outcomes, to reduce unnecessary computational and communication load, and to provide more context-appropriate and resource-efficient modification candidate information in single-user and multi-user computing environments.

The term “text information” refers to digital information including one or more character strings that represent natural language content, such as sentences, paragraphs, lists, or messages, which are processed by the processor.

The term “structure of the text information” refers to a configuration of the text information, including at least segmentation into sentences and paragraphs, presence and arrangement of enumeration elements, and distribution of characters or tokens within the text.

The term “amount of characters” refers to a quantitative measure of characters or tokens contained in the text information, including at least a count of symbols, letters, or units of text used for structural analysis and threshold evaluation.

The term “amount of enumeration information” refers to a quantitative measure of list-like or enumerated elements contained in the text information, including at least a count of items represented as bullet points, numbered lists, or similar enumeration formats.

The term “reference value” refers to a threshold or criterion derived from structural metrics of the text information, such as the amount of characters or the amount of enumeration information, which is used by the processor to determine whether to request generation of modification candidate information.

The term “modification candidate information” refers to information generated for the purpose of revising or improving the text information, including at least alternative phrasings, restructured text, or suggested changes in tone or style.

The term “prompt sentence” refers to a control string or instruction text provided as input to a generative information processing model, the control string specifying at least a task, a target range, and an adjustment policy for generating the modification candidate information.

The term “generative information processing model” refers to a computational model that generates new text or transformed text in response to an input prompt sentence, using machine learning or artificial intelligence techniques, and that outputs at least the modification candidate information for the text information.

The term “emotion analysis processing” refers to processing that analyzes text information or reaction information to derive emotion evaluation information, including at least detection or classification of emotion types and intensities.

The term “emotion evaluation information” refers to data representing one or more emotional states associated with a subject, such as degree of negativity, positivity, joy, sadness, anger, or other affective attributes, derived by emotion analysis processing.

The term “transmission subject” refers to an entity, such as a user or a computing component acting on behalf of a user, that provides or originates the text information to be processed by the system.

The term “reception subject” refers to an entity, such as a user or a group of users, that receives or is intended to receive the text information and the modification candidate information generated by the system.

The term “tone adjustment” refers to modification of the modification candidate information based on emotion evaluation information, including at least mitigation of negative expressions, enhancement of positive expressions, or balancing of emotional nuance between multiple subjects.

The term “emotion difference” refers to a disparity between emotion evaluation information of a transmission subject and emotion evaluation information of a reception subject or a group of reception subjects, used as a control signal for tone adjustment.

The term “record information” refers to stored information including at least the text information, structural metrics, reference values, prompt sentences, emotion evaluation information, modification candidate information, tone adjustment results, and user interaction outcomes, which are used for subsequent learning control.

The term “learning control” refers to processing in which the processor updates at least one system parameter, such as the reference value or prompt sentence generation conditions, based on record information, to improve future behavior of the system.

The term “generation condition of the prompt sentence” refers to one or more rules, parameters, or templates used by the processor to construct the prompt sentence, including at least selection of instructions, inclusion of structural or emotional context, and formatting of the input to the generative information processing model.

The term “communication processing” refers to operations for transmitting information between the server and one or more external devices or entities, including at least sending the modification candidate information and receiving text information via a communication network.

The term “delivery target subject” refers to one or more reception subjects or other entities designated to receive the modification candidate information or associated information via communication processing.

The term “user interface” refers to a hardware and software configuration that presents information generated by the system to a user and receives input from the user, including at least display elements and input controls for interacting with the modification candidate information.

The term “reaction information” refers to information representing responses of one or more reception subjects to the text information or the modification candidate information, including at least reply texts, comments, evaluations, or interaction signals.

The term “collective emotion evaluation information” refers to emotion evaluation information obtained by aggregating or summarizing emotion analysis results for reaction information from a plurality of reception subjects.

The term “common information” refers to modification candidate information generated in a shared form intended to be presented to multiple reception subjects based on collective emotion evaluation information.

The term “individualized information” refers to modification candidate information generated in a personalized form for each reception subject or each subset of reception subjects, based on respective emotion evaluation information or differentiated conditions.

In one or more embodiments, a server, a terminal, and a user cooperate to implement a system that generates and delivers modification candidate information for text information by combining structured text analysis, emotion analysis, and a generative AI model controlled by a dynamically constructed prompt sentence. The server includes at least one processor, a memory, a communication interface, and a non-transitory storage medium storing instructions that, when executed by the processor, cause the server to perform the functions described below. The terminal includes at least one processor, a memory, a display device, an input device, and a communication interface for communicating with the server via a network.

### A. Hardware and Software Configuration

The server runs on a computing apparatus such as a rack-mounted or virtualized server executing an operating system, for example, a UNIX-like operating system. The server uses a web application framework, for example, a framework that provides HTTP request handling, routing, and JSON parsing. The server uses a relational database management system to store text information, structural metrics, emotion evaluation information, prompt sentences, modification candidate information, and record information.

The server executes a natural language processing library, for example, a library implementing tokenization, sentence segmentation, and part-of-speech tagging, to perform structural analysis of text information. The server executes an emotion analysis engine, for example, an engine that implements a supervised classifier over word embeddings or sentence embeddings, to derive emotion evaluation information. The server communicates with a generative AI model as a service or an on-premise neural network engine. The generative AI model may be a transformer-based neural network trained on large-scale corpora for conditional text generation.

The terminal runs on a client device such as a smartphone, a tablet computer, or a desktop computer. The terminal executes a browser or a native application that implements a user interface. The terminal includes modules for sending text information to the server, receiving modification candidate information, and displaying the modification candidate information in relation to the original text information.

### B. Generative AI Model Structure and Training

The server uses a generative AI model that is implemented as a multi-layer transformer neural network. The model includes an embedding layer that converts discrete token identifiers into dense vectors, a plurality of self-attention layers that compute attention scores between tokens, and feed-forward layers that transform intermediate representations. Each self-attention layer includes a query, key, and value projection, scaled dot-product attention, and residual connections. The model output layer maps hidden states to probability distributions over vocabulary tokens.

The generative AI model is trained prior to deployment using a large corpus of text data. The server (or an external training system) trains the model by minimizing a loss function such as cross-entropy between predicted token distributions and ground-truth tokens. A gradient-based optimization method such as stochastic gradient descent or an adaptive optimizer is applied to update model weights. The training data may be augmented by data augmentation techniques such as synonym substitution, back-translation, or random masking to increase robustness. The training procedure may include regularization techniques such as dropout, layer normalization, and weight decay.

The server optionally performs fine-tuning of the generative AI model using domain-specific corpora and feedback from user interactions within the system. The server stores pairs of input prompt sentences and desired output texts as training examples and uses these examples to further adjust model parameters. The server uses an error function that incorporates both token-level accuracy and higher-level metrics, such as style or tone similarity scores, to guide weight updates. This fine-tuning allows the generative AI model to better respond to the specific prompt sentence formats used by the system and to produce modification candidate information that is more consistent with the structural and emotional constraints determined by the server.

### C. Data Structures and Internal Representations

The server stores text information and associated metadata in structured records. For example, the server uses a record including fields such as:
text_id: an identifier for the text information,
user_id: an identifier for the transmission subject,
raw_text: the original text information,
character_count: the amount of characters,
enumeration_count: the amount of enumeration information,
reference_value: the current threshold applied to the text information,
emotion_author: emotion evaluation information for the transmission subject,
emotion_audience: collective emotion evaluation information for reception subjects,
prompt_template_id: an identifier for the prompt template used,
prompt_sentence: the actual prompt sentence submitted to the generative AI model,
modification_candidate_text: the revised text proposed by the model,
tone_adjusted_text: a version of the modification candidate text after tone adjustment,
adoption_status: information representing whether and how a user adopted the suggestion.

The server maintains a prompt template table that defines different prompt patterns for different use cases, including length reduction, restructuring of enumeration, and tone softening or balancing. Each template includes placeholders for the original text, structural metrics, and emotion evaluation information. The server uses these templates to construct a precise prompt sentence tailored to the specific situation.

The server also stores reference value configurations. These configurations include baseline thresholds for character_count and enumeration_count, as well as adjustment policies that change thresholds based on historical record information. The server can represent reference values as numeric parameters associated with each content type or user profile.

### D. Structural Analysis and Threshold Control

The server uses the natural language processing library to analyze the structure of the text information. The server converts the raw_text field into a sequence of tokens, segments the sequence into sentences, and identifies newline characters or list markers indicating enumeration elements. The server counts characters and tokens and counts lines or segments that match enumeration patterns.

The server sets a reference value based on the measured character_count and enumeration_count. For example, the server computes a weighted sum or a piecewise function that decides whether the text is considered long or heavily enumerated. The server can also combine these metrics with other structural features, such as average sentence length or number of paragraphs, to compute a composite reference value.

The server then determines whether the text information exceeds the reference value. If the text information does not exceed the reference value, the server may skip invocation of the generative AI model or select a simplified assistant function. If the text information exceeds the reference value, the server decides to request generation of modification candidate information and selects an appropriate prompt template and adjustment policy. This conditional control prevents unnecessary calls to the generative AI model, thereby reducing network usage, processor load, and latency. By using structural metrics as explicit decision criteria, the server improves computational efficiency compared with a naive approach that always calls the model regardless of text length or complexity.

### E. Emotion Analysis and Tone Adjustment

The server performs emotion analysis processing on the text information and, optionally, on reaction information from multiple reception subjects. The server converts text information into numerical features, for example, using a sentence embedding model or a bag-of-words representation with sentiment lexicons. The server then feeds these features into a classifier such as a neural network or a support vector machine that outputs probabilities for emotion categories (for example, joy, sadness, anger, fear, neutral) and a polarity score.

The server generates emotion evaluation information representing the emotion states of the transmission subject (emotion_author) and of the reception subjects collectively (emotion_audience). The server stores these values alongside the text information. The server then computes an emotion difference measure, for example, a distance between emotion vectors of the transmission subject and of the reception subjects.

The server modifies the modification candidate information by applying a tone adjustment algorithm. The server defines rules or learned mappings that, given the emotion_author, emotion_audience, and emotion difference, determine whether to mitigate negative expressions, enhance positive expressions, or introduce empathetic language. The server may use a second generative pass in which the tone-adjusted text is generated by providing an additional prompt sentence that explicitly instructs the generative AI model to soften or balance tone. Alternatively, the server may apply post-processing transformations based on lexical replacement tables or semantic similarity constraints.

Because the tone adjustment is driven by explicit emotion evaluation information and emotion difference metrics, the server can systematically align the modification candidate information with the emotional context of both the author and the audience. This reduces the need for repeated manual corrections and prevents generation of context-insensitive messages, thereby improving the overall effectiveness and precision of the system.

### F. Prompt Sentence Generation and Model Invocation

The server constructs a prompt sentence by selecting a prompt template and filling placeholders with the original text, structural metrics, and emotion evaluation information.

The server may generate different prompt sentences depending on the objectives, such as length reduction, clarity improvement, or conflict mitigation between emotional states.

Examples of prompt sentences include:
“The following Japanese report is long and contains many bullet points. Please make it more concise (about 800 characters) and reorganize the bullet list for clarity, while keeping the key information. Text: ‘Insert report text here’”
“Analyze the following user comment written in Japanese. Detected emotion: strong negativity. Please generate a revised version that softens the negative tone but preserves the main message. Comment: ‘This project is not going well at all. I want to quit.’”
“User's post expresses joy, but other users show sadness in their reactions. Please propose a revision that keeps the joy but adds empathy for people who feel sad. Post: ‘I had a great time today!’”

The server uses these prompt sentences as input to the generative AI model. The server configures model parameters such as maximum output length, sampling temperature, and decoding strategy (for example, greedy decoding or beam search), to control output diversity and determinism. Because the prompt sentence encodes structural thresholds and emotional context, the generative AI model is effectively guided to produce modification candidate information that adheres to the system's constraints. This prompt-based control mechanism differs from simple automation of human editing and constitutes a technical mechanism for improving generative output quality and reducing extraneous content, which in turn reduces network and storage requirements.

### G. Learning Control and Adaptive Behavior

The server performs learning control by analyzing record information accumulated over time. The server evaluates correlations between structural metrics, emotion evaluation information, prompt templates, and user adoption outcomes. For instance, the server can compute, for each prompt_template_id, an acceptance rate and measure how often users partially or fully adopt the tone_adjusted_text.

Based on these statistics, the server updates reference values and prompt generation conditions. For example, if users frequently accept suggestions when text length is slightly below an original threshold, the server may lower or raise the reference value accordingly. The server may also adjust which emotion categories trigger tone modification or how much emphasis is placed on audience emotion.

The server may apply machine learning techniques to model the relationship between input features (for example, character_count, enumeration_count, emotion_author, emotion_audience) and desired control decisions (for example, which prompt template to use and whether to request the generative AI model). In one embodiment, the server trains a decision model that outputs a recommended prompt template and parameter set. The server uses a loss function that penalizes wrong decisions that led to low adoption or user dissatisfaction and updates the decision model's parameters using gradient-based optimization.

As a result of this learning control, the server gradually improves its ability to select appropriate thresholds and prompt conditions, which leads to more efficient use of generative AI model calls and higher-quality modification candidate information. This dynamic adaptation is not a mere automation of human judgment but a technical optimization of computational resource allocation and model invocation policy inside the computer system.

### H. Terminal-Side Presentation and Interaction

The terminal receives modification candidate information and tone adjustment results from the server via a communication interface. The terminal stores this information temporarily in its memory and updates the user interface. The terminal displays original text information and modification candidate information in a comparative format, for example, side-by-side panels or integrated highlighting of changed segments.

The terminal uses different visual styling (for example, colors, underlines, or icons) to indicate the nature of modifications, such as length reduction or tone softening. The terminal provides interactive controls that allow the user to adopt all changes, adopt individual segments, or reject the proposal. When the user selects partially or fully adopted changes, the terminal composes a new text version and may send it back to the server as updated text information, thereby participating in the feedback loop that supports learning control. Because the terminal maintains a specific data structure for mapping original segments to suggested segments, the user interface can support granular operations that are not trivial to perform manually. This granular mapping and interactive update reduce user cognitive load and input operations, but, more importantly, they allow the system to record detailed adoption patterns per segment, which the server can use to refine its models and thresholds.

### I. Technical Effects and Advantages

The server improves the operation of the computer system as a whole by introducing a multi-layer control mechanism over the generative AI model that relies on structural analysis, emotion evaluation, and learning control.

First, structural thresholding reduces unnecessary invocations of the generative AI model and thus saves CPU time, GPU time, and bandwidth. The server only requests generation when objective measures such as character_count and enumeration_count exceed reference values.

This behavior provides a direct causal link between structural metrics and resource utilization.

Second, emotion-based tone adjustment reduces the number of iterations required to achieve an acceptable text revision. By explicitly modeling emotion_author, emotion_audience, and emotion difference, the server avoids generating tone-inappropriate suggestions that would be rejected and retried. This reduces repeated processing and stabilizes the system behavior.

Third, record-based learning control enables continuous improvement of reference values and prompt generation conditions. The server uses past interactions to modify internal parameters, leading to more accurate decisions regarding when and how to call the generative AI model. This adaptation improves processing speed (by avoiding unnecessary work) and output precision (by selecting more suitable prompts).

Fourth, multi-user emotion evaluation and generation of common or individualized modification candidate information enable efficient handling of group communication scenarios. The server aggregates reactions and uses collective emotion evaluation information to determine whether a single shared suggestion or multiple customized suggestions are necessary. This avoids redundant calls to the generative AI model for each user when a common suggestion suffices, thereby reducing computation and communication load.

Fifth, by utilizing specific data structures for text, metrics, emotion information, and prompts, and by implementing non-trivial control flows that operate on these structures, the system departs from generic “data-receive/data-analyze/data-display” patterns and achieves concrete technical improvements in how the computer manages limited resources and processes large volumes of user-generated text.

In summary, the server, the terminal, and the generative AI model cooperate under the described architecture to implement a system that not only assists users with text revision but also improves the internal functioning of the computing environment through structured analysis, adaptive thresholds, emotion-aware control, and feedback-driven refinement of prompt sentences and model usage.

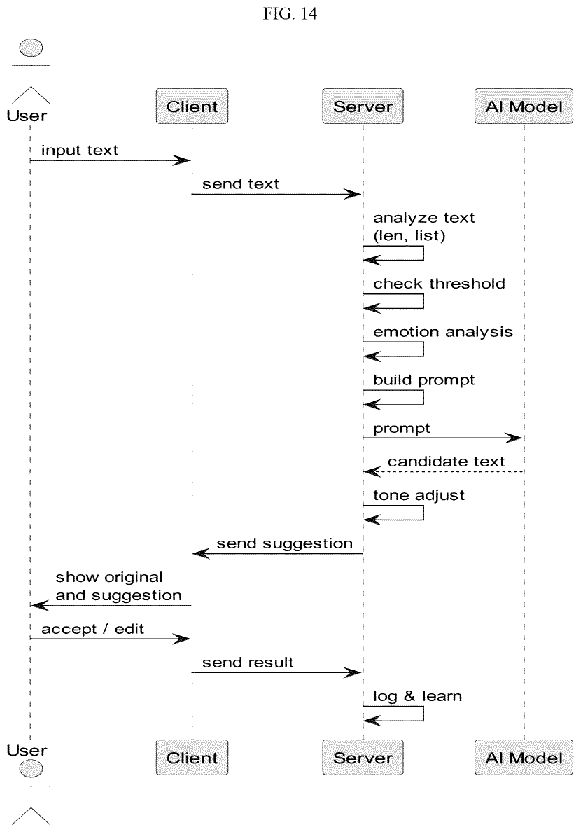

The following describes the processing flow using FIG. 14.

### Step 1:

User operates the terminal and inputs text information into a text input component such as a text box in a browser or application.

User provides as input a character string (for example, “I had a great time today.”). Terminal uses this input to construct a request object that includes at least the raw text, a user identifier, and a content type flag.

Terminal outputs a structured data packet (for example, JSON over HTTPS) containing the text information and metadata, and sends it to the server via a communication interface.

### Step 2:

Server receives the structured data packet from the terminal through a network interface.

Server takes as input the packet containing the raw text and user metadata.

Server parses the packet, extracts the raw text field, user identifier, and context information, and verifies basic integrity (for example, encoding, maximum length).

Server outputs a normalized internal record that includes the text information and metadata, and stores this record in a persistent storage medium with a newly assigned text identifier.

### Step 3:

Server performs structural analysis on the stored text information using a natural language processing library.

Server takes as input the raw text associated with the text identifier.

Server tokenizes the text into characters and tokens, segments the text into sentences and paragraphs, and applies pattern matching to detect enumeration elements such as bullet points or numbered lists.

Server calculates structural metrics including at least a character_count and an enumeration_count by counting the number of characters and the number of detected enumeration segments.

Server outputs an updated record that includes these structural metrics, and stores the metrics in association with the text identifier.

### Step 4:

Server determines whether the structural metrics exceed a reference value and decides whether to request generation of modification candidate information.

Server takes as input the character_count, enumeration_count, and current reference value configuration for the target content type or user profile.

Server applies a comparison operation and optionally a weighted function to compute a score, and evaluates whether the score exceeds a threshold representing the reference value.

Server outputs a control decision flag (for example, needs_revision=true or false) and, when needs_revision is true, selects a revision type such as length reduction, enumeration reorganization, or tone adjustment, and updates the record with this decision.

### Step 5:

Server performs emotion analysis processing on the text information to obtain emotion evaluation information for the transmission subject.

Server takes as input the raw text and optional language code.

Server converts the text into numerical features using a feature extraction algorithm (for example, sentence embeddings or weighted bag-of-words), and feeds the features into an emotion classifier model that outputs probabilities or scores for emotion categories such as positive, negative, joy, sadness, anger, or neutral.

Server derives an emotion label and intensity values from these scores and outputs emotion evaluation information for the author (for example, emotion_author=negative, intensity=0.82), and stores this information in association with the text identifier.

### Step 6:

Server aggregates reaction information from reception subjects (when available) and performs emotion analysis to obtain collective emotion evaluation information.

Server takes as input reaction texts or interaction signals (for example, comments or replies) associated with the same thread or text identifier.

Server applies the same feature extraction and emotion classification procedures to each reaction text, and then aggregates the emotion scores across multiple reception subjects using statistical operations such as averaging or weighted averaging.

Server outputs collective emotion evaluation information (for example, emotion_audience=sadness, intensity=0.6) and a measure of emotion difference between the transmission subject and the reception subjects, and stores these values in the record.

### Step 7:

Server selects a prompt template and generates a concrete prompt sentence for the generative AI model.

Server takes as input the raw text, the structural metrics, the control decision flag, the revision type, and the emotion evaluation information for the author and audience.

Server selects a prompt template that corresponds to the revision type (for example, length reduction, tone softening, or multi-party emotion balancing) and substitutes placeholders in the template with the actual text, metrics, and emotion labels.

Server outputs a fully constructed prompt sentence such as:
“The following Japanese report is long and contains many bullet points. Please make it more concise (about 800 characters) and reorganize the bullet list for clarity, while keeping the key information. Text: ‘Insert report text here’”
or
“User's post expresses joy, but other users show sadness in their reactions. Please propose a revision that keeps the joy but adds empathy for people who feel sad. Post: ‘I had a great time today!’”
and stores this prompt sentence in association with the text identifier.

### Step 8:

Server invokes the generative AI model by sending the prompt sentence and model parameters to a generative information processing engine.

Server takes as input the prompt sentence, a selected model configuration (for example, model name, maximum tokens, temperature), and any decoding strategy parameters such as beam width or top-k sampling.

Server constructs an API request or internal model call that embeds the prompt sentence and parameters, and transmits this request to the generative AI model engine running on local hardware or on a remote service.

Server receives as output a generated text sequence from the generative AI model, which represents initial modification candidate information, and stores this generated text in the record as modification_candidate_text.

### Step 9:

Server post-processes the modification candidate text and performs tone adjustment based on emotion evaluation information.

Server takes as input the modification_candidate_text, emotion_author, emotion_audience, and emotion difference values.

Server first normalizes the candidate text by trimming whitespace, adjusting encoding, and validating character sets. Then, based on explicit rules or a secondary control model, server decides whether additional tone adjustment is required (for example, softening overly negative phrases or adding empathetic language to respect audience sadness).

Server may generate an additional prompt sentence that explicitly requests tone adjustment and provide the modification_candidate_text and emotion context to the generative AI model, or may apply a deterministic post-processing algorithm that replaces or rephrases certain expressions using lexicon-based mapping.

Server outputs tone_adjusted_text, which is the final modification candidate information after tone adjustment, and stores this text in the record.

### Step 10:

Server logs the processing results as record information and updates internal parameters through learning control.

Server takes as input the structural metrics, the reference value, the prompt sentence, the modification_candidate_text, the tone_adjusted_text, and any available adoption_status from previous cycles.

Server writes these values into structured record information for long-term storage and statistical analysis. Server then executes learning control logic that analyzes accumulated records to update reference values or prompt selection strategies, for example by recalculating thresholds or adjusting template weights based on historical adoption rates.

Server outputs updated system parameters such as a revised reference value or new template selection rules, and stores these parameters in configuration storage to be used in future executions.

### Step 11:

Server prepares a distribution payload and executes communication processing to deliver the modification candidate information to target reception subjects.

Server takes as input the tone_adjusted_text and delivery configuration that specifies whether to send common information or individualized information to one or more reception subjects.

Server constructs a response payload that includes the original text information, the tone_adjusted_text, and optional explanatory metadata (for example, type of revision and key changes), and encapsulates this payload in a format suitable for the terminal (for example, JSON for a web API response or push notification content).

Server outputs the payload to the network interface and transmits it to the relevant terminals, updating the record to indicate that delivery has been performed.

### Step 12:

Terminal receives the payload from the server and updates the user interface to present the modification candidate information.

Terminal takes as input the payload including the original text, the tone_adjusted_text, and metadata.

Terminal parses the payload, creates internal UI models that map original segments to revised segments, and renders visual components such as side-by-side views or in-line highlights to show differences between the original text and the modification candidate information.

Terminal outputs a visual presentation on the display, enabling the user to clearly see the proposed changes and providing interactive controls such as buttons or toggles for applying or rejecting suggestions.

### Step 13:

User interacts with the terminal to accept, partially accept, or reject the modification candidate information.

User observes the original text and the tone_adjusted_text, and provides as input one or more operations, such as selecting specific segments to adopt or pressing an “Apply All” or “Reject” button.

Terminal processes this user input to construct an updated version of the text that reflects the adopted segments, and optionally records the degree of adoption for each segment as interaction data.

Terminal outputs either a new text version to be sent back to the server as updated text information, or a status message indicating rejection, and sends this output to the server for logging and potential use in future learning control.

### Step 14:

Server receives the user interaction outcome and updates adoption_status and learning data.

Server takes as input the interaction data from the terminal, including which parts of the tone_adjusted_text were adopted or rejected.

Server updates the record associated with the text identifier to store adoption_status and detailed adoption metrics per segment. Server then incorporates this new data into the learning control process by recomputing statistics (for example, acceptance rates per prompt template or per structural range) and adjusting model usage policies if necessary.

Server outputs refreshed learning parameters and keeps the record information updated, so that subsequent processing cycles for other texts can benefit from the observed user behavior and yield more efficient and accurate modification candidate generation.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

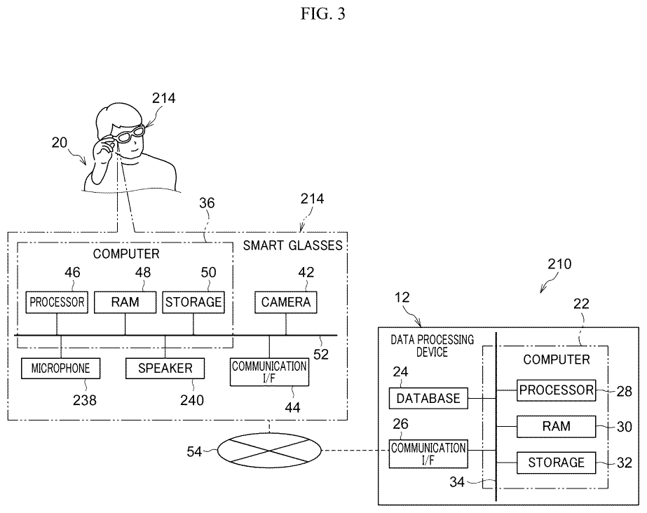

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

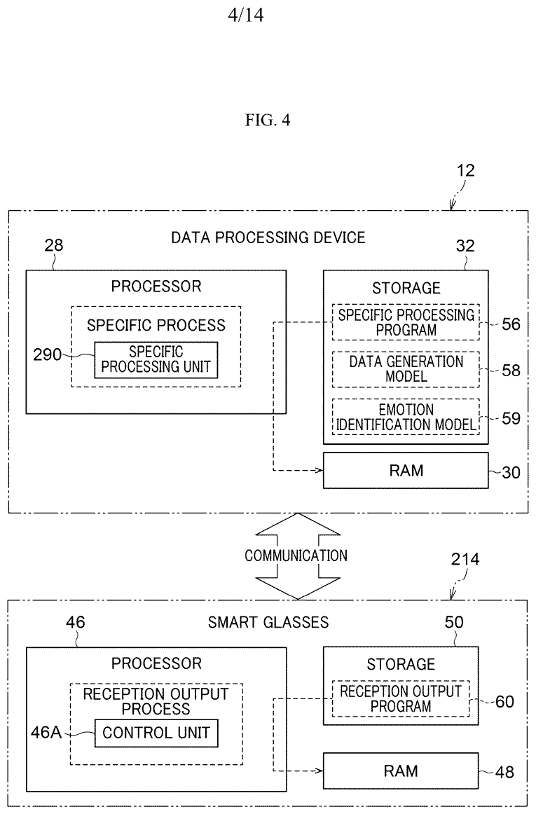

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

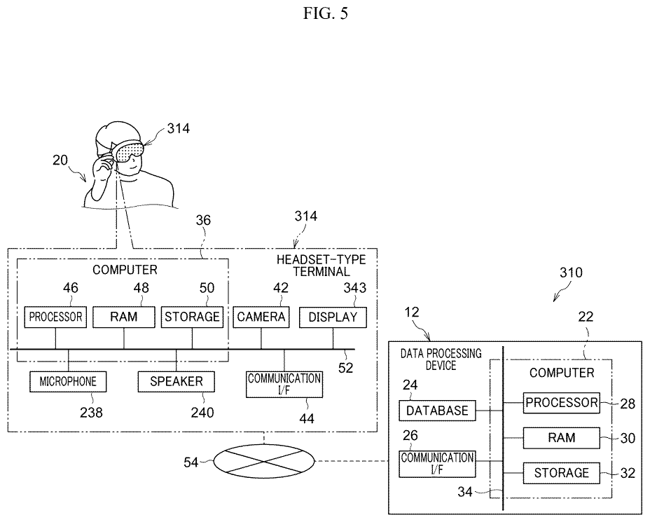

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

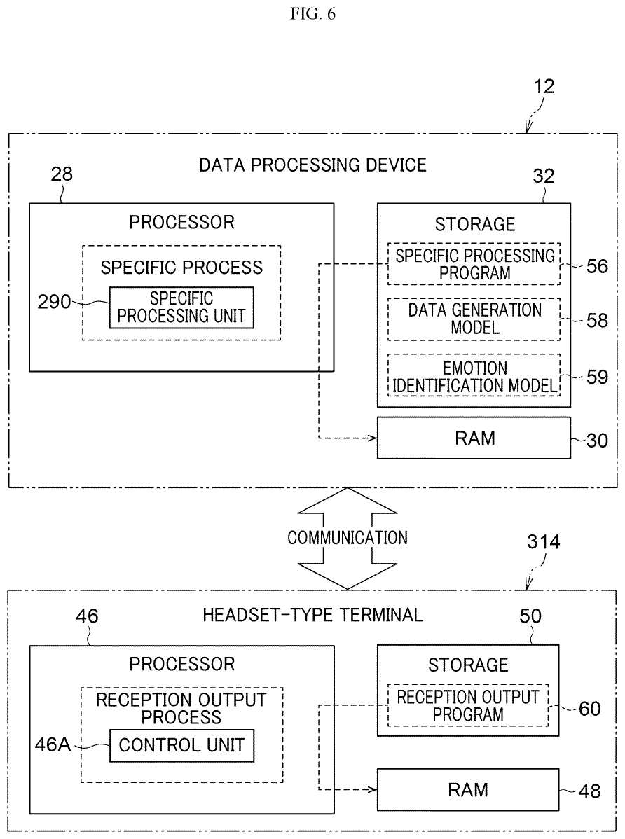

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

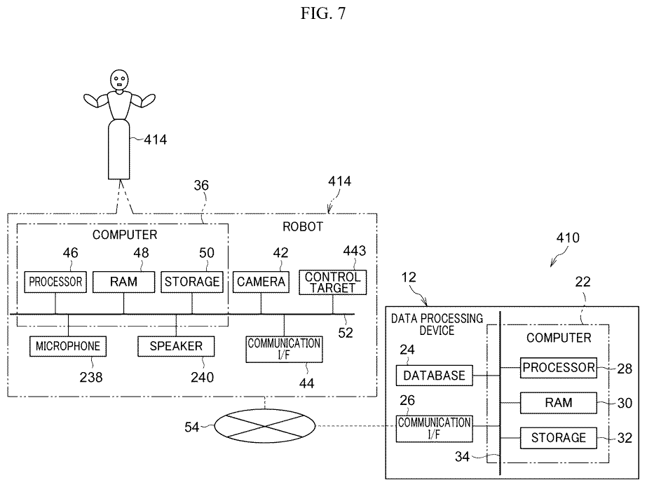

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

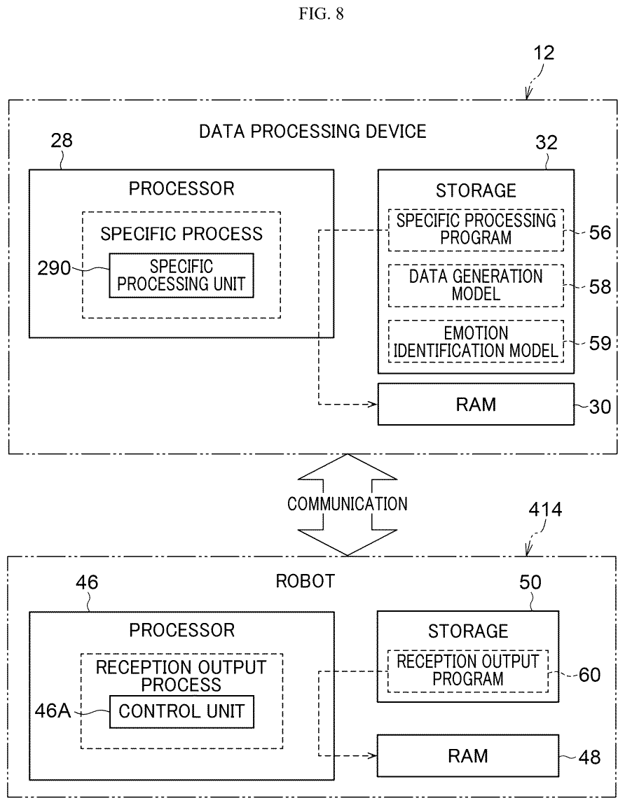

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

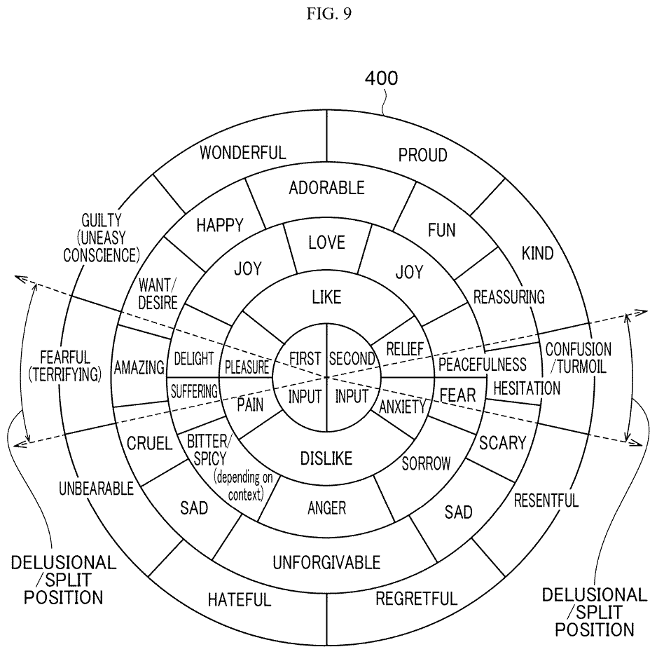

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

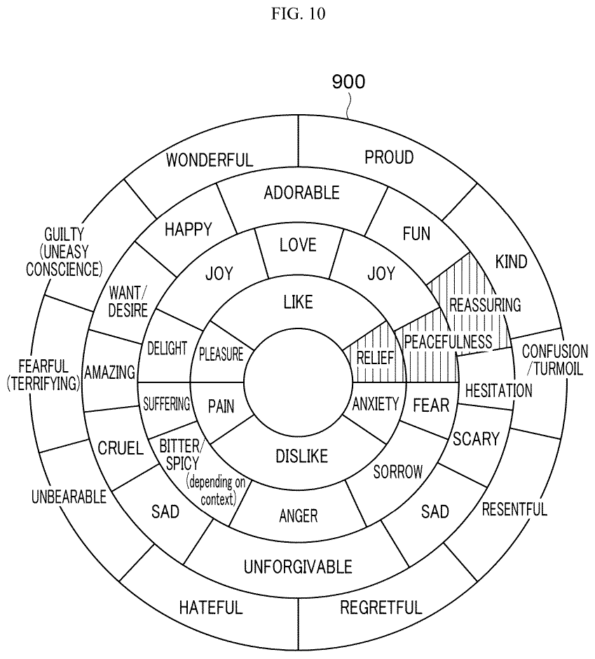

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
receive text data from a communication terminal,
analyze the received text data to detect a length of character information and a number of elements in a list structure, and obtain an analysis result including the length of the character information and the number of elements in the list structure,
determine and set a threshold for the length of the character information and a threshold for the number of elements in the list structure by acquiring or generating the thresholds from a storage device on the basis of the analysis result, and determine whether the analysis result exceeds at least one of the thresholds,
when a determination that at least one of the thresholds is exceeded is made, generate a prompt sentence including at least one of text improvement information, threshold information, and the analysis result, and generate request data for inputting the prompt sentence to a generative information processing model, and transmit the request data to an external information processing service,
receive response data including a revision proposal generated by the generative information processing model on the basis of the prompt sentence, extract the revision proposal from the response data, and format the revision proposal as improvement information for the text data, store, in a recording medium, the analysis result, the thresholds, and the revision proposal in association with one another, and
generate feedback information including the analysis result and the revision proposal, and transmit the feedback information to the communication terminal.

### (Supplementary 2)

The system according to supplementary 1,
wherein the processor is configured to
generate the feedback information so as to include explanation information for prompting simplification when the length of the character information exceeds the threshold for the length of the character information and to include summary text generated by the generative information processing model, and to include explanation information for prompting integration or reduction of the list structure and list-reconstructed text generated by the generative information processing model when the number of elements in the list structure exceeds the threshold for the number of elements in the list structure.

### (Supplementary 3)

The system according to supplementary 1,
wherein the processor is configured to
generate the prompt sentence as a structure including an instruction sentence selected from a plurality of prompt patterns in accordance with at least one of a type of the text data, the length of the character information, the number of elements in the list structure, and the thresholds, and to request, from the generative information processing model, at least one of summarization, simplification, and reconstruction of the list structure in accordance with the selected prompt pattern.

### Application Example 1

### (Supplementary 1)

A system comprising a processor,
wherein the processor is configured to
receive text information from a terminal device via a communication control function, analyze the text information by detecting a length of a character string included in the text information and detecting a number of elements of a list expression included in the text information,
acquire reference value information corresponding to the length of the character string and the number of elements of the list expression from a storage region, or set the reference value information based on an analysis result of the text information,
compare the analysis result with the reference value information and, when at least one of the length of the character string and the number of elements of the list expression is determined to exceed the reference value information, generate prompt sentence information including instruction content that the text information is to be simplified and main points of the text information are to be extracted, and including the text information,
input the prompt sentence information to a generative information processing model and cause the generative information processing model to execute natural language generation processing to generate refinement proposal information of the text information, and generate response information in which the refinement proposal information is associated with the analysis result and transmit the response information to the terminal device via the communication control function.

### (Supplementary 2)

The system according to supplementary 1,
wherein the processor is configured to
control the terminal device so that a user interface is generated, the user interface being configured to visually present the refinement proposal information included in the response information by a display control function of the terminal device and to accept at least one of an adoption operation and a modification operation by a user with respect to the refinement proposal information.

### (Supplementary 3)

The system according to supplementary 1,
wherein the processor is configured to
execute, within a predetermined delay time from reception of a request from the terminal device, processing of receiving the text information, processing of analyzing the text information, processing of generating the prompt sentence information, processing of inputting the prompt sentence information to the generative information processing model, and processing of transmitting the refinement proposal information, thereby providing a response having real-time properties.

### Example 2

### (Supplementary 1)

A system comprising a processor,
wherein the processor is configured to
receive text data from a terminal via a communication path,
analyze the received text data to calculate evaluation indices including at least character count and a number of bullet points as text structure information, and dynamically set threshold information including generation conditions based on the evaluation indices, generate, when the set threshold information satisfies a predetermined condition, a prompt sentence that includes at least a part of the text data and instructs analysis and creation of a revision proposal regarding grammar, writing style, and content coherence,
transmit the prompt sentence, via a communication protocol, to a generation computation unit included in an external generative AI model, and receive revision proposal data generated by the generative AI model,
reconstruct the received revision proposal data in accordance with notification conditions and provision media for each user, and format the reconstruction as notification message data, and
transmit the notification message data to the terminal via an electronic communication service or an information delivery service.

### (Supplementary 2)

The system according to supplementary 1,
wherein the processor is configured to
perform the reconstruction such that the notification message data includes at least original text data, classification information of issues detected based on the evaluation indices, and at least a part of the revision proposal generated by the generative AI model.

### (Supplementary 3)

The system according to supplementary 1,
wherein the processor is configured to
switch an expression format and instruction content including a revision policy of the prompt sentence in accordance with user attribute information or designation information regarding a language type and an expression style of the text data.

### Application Example 2

### (Supplementary 1)

A system comprising a processor,
wherein the processor is configured to
receive text information,
analyze a structure of the received text information to detect an amount of characters and an amount of enumeration information,
set a reference value based on the detected amount of characters and the detected amount of enumeration information, and determine, for text information exceeding the reference value, whether to request generation of a modification candidate,
generate a prompt sentence including content of the modification candidate generation, a target range, and an adjustment policy, based on a determination result and the text information,
input the generated prompt sentence into a generative information processing model to cause the generative information processing model to generate modification candidate information for the text information,
execute emotion analysis processing on the text information to obtain emotion evaluation information representing emotion states of a transmission subject and a reception subject, modify the modification candidate information so as to perform tone adjustment including mitigation of negative emotion, enhancement of positive emotion, and adjustment of an emotion difference between the transmission subject and the reception subject, based on the emotion evaluation information and the modification candidate information, store the modification candidate information and a tone adjustment result as record information, and perform learning control to update a generation condition of the prompt sentence and the reference value based on the record information, and
execute communication processing to distribute the modification candidate information to a delivery target subject.

### (Supplementary 2)

The system according to Supplementary 1,
wherein the processor is configured to
cause a user interface to display the modification candidate information and the tone adjustment result in a format comparable with original text information, and receive operation input from the reception subject for partially adopting, entirely adopting, or not adopting the modification candidate information.

### (Supplementary 3)

The system according to Supplementary 1,
wherein the processor is configured to
execute the emotion analysis processing on reaction information acquired from a plurality of reception subjects, generate collective emotion evaluation information based on the reaction information, and generate the modification candidate information as common information or individualized information for the plurality of reception subjects based on the collective emotion evaluation information, and notify each of the plurality of reception subjects of the modification candidate information.

What is claimed is:

1. A system comprising:
circuitry configured to:
receive, via a communication interface coupled to a packet-switched network, text data from a terminal device and store the text data in a storage device;
analyze the text data to calculate a character string length value and a list-element count value by applying pattern-matching processing to detect individual elements of a list structure within the text data;
acquire reference value information comprising a character string length threshold and a list-element count threshold from the storage device, compare the character string length value and the list-element count value against the reference value information, and set a threshold exceedance flag when at least one of the character string length value or the list-element count value exceeds the corresponding threshold;
when the threshold exceedance flag is set, select a prompt pattern from a plurality of stored prompt patterns based on which threshold was exceeded and generate prompt sentence information by inserting instruction content and the text data into the selected prompt pattern, and transmit request data comprising the prompt sentence information to a generative neural network model via the communication interface;
receive response data comprising revision proposal information generated by the generative neural network model based on the prompt sentence information, extract the revision proposal information from the response data, and store the character string length value, the list-element count value, the reference value information, and the revision proposal information in association with one another in the storage device; and
generate feedback information comprising the revision proposal information and the character string length value and list-element count value, and transmit the feedback information to the terminal device via the communication interface.

2. The system according to claim 1, wherein the circuitry is configured to detect the list structure by applying rule-based pattern matching to identify line-initial markers indicating list elements, count the identified markers to produce the list-element count value, and determine the character string length value by counting character units in the text data.

3. The system according to claim 2, wherein the circuitry is configured to select the prompt pattern by evaluating a configuration table that maps combinations of threshold exceedance conditions and a language identifier associated with the text data to specific prompt pattern identifiers, and to insert the character string length value, the list-element count value, and the reference value information as metric fields into the selected prompt pattern.

4. The system according to claim 3, wherein the circuitry is configured to generate, when the character string length value exceeds the character string length threshold, prompt sentence information that instructs the generative neural network model to produce summary text that reduces overall length while preserving principal content, and generate, when the list-element count value exceeds the list-element count threshold, prompt sentence information that instructs the generative neural network model to produce list-reconstructed text that groups or reduces list elements.

5. The system according to claim 4, wherein the circuitry is configured to generate feedback information that includes, when the character string length value exceeds the character string length threshold, explanation information indicating that the character string length exceeded the threshold and including the summary text generated by the generative neural network model, and includes, when the list-element count value exceeds the list-element count threshold, explanation information indicating that the list-element count exceeded the threshold and including the list-reconstructed text generated by the generative neural network model.

6. The system according to claim 1, wherein the circuitry is configured to complete processing from receiving the text data to transmitting the feedback information within a predetermined delay time by applying hardware-accelerated inference to execute the generative neural network model, and by omitting transmission to the generative neural network model when neither threshold is exceeded.

7. The system according to claim 1, wherein the circuitry is configured to dynamically adjust the reference value information by analyzing accumulated analysis result records stored in the storage device, computing statistical measures of historical character string length values and list-element count values, and updating the character string length threshold and list-element count threshold based on the computed statistical measures.

8. The system according to claim 7, wherein the circuitry is configured to store, in the storage device, a prompt pattern identifier associated with each stored record, aggregate performance statistics for each prompt pattern identifier, and adjust the prompt pattern selection mapping based on the aggregated performance statistics to improve conformity of revision proposal information to target structural constraints.

9. The system according to claim 1, wherein the circuitry is configured to apply rule-based post-processing to the revision proposal information to verify that a character string length of the revision proposal information does not exceed a maximum output length parameter, and to truncate or re-invoke the generative neural network model when the verified length exceeds the maximum output length parameter.

10. The system according to claim 1, wherein the circuitry is configured to execute emotion analysis processing on the text data to derive emotion evaluation information representing an estimated emotional state of at least one of a transmission subject or a reception subject of the text data, and generate modification candidate information by adjusting the revision proposal information based on the emotion evaluation information to perform at least one of negative emotion mitigation, positive emotion enhancement, or emotion-difference adjustment between the transmission subject and the reception subject.

11. The system according to claim 10, wherein the circuitry is configured to store the revision proposal information and a tone adjustment result as record information in the storage device, and perform learning control processing to update the reference value information and a prompt generation condition based on the record information, and transmit the modification candidate information as the feedback information to the terminal device via the communication interface.

12. The system according to claim 11, wherein the circuitry is configured to execute the emotion analysis processing on reaction information received from a plurality of terminal devices associated with a plurality of reception subjects, generate collective emotion evaluation information based on the reaction information, and generate the modification candidate information as at least one of common modification information applicable to all reception subjects or individualized modification information specific to each reception subject based on the collective emotion evaluation information.

13. The system according to claim 1, wherein the circuitry is configured to control the terminal device to generate a user interface that presents the revision proposal information alongside the original text data and that accepts an adoption operation in which the revision proposal information replaces the original text data in an input field of the terminal device, or a modification operation in which the user edits the revision proposal information before submission.

14. The system according to claim 1, wherein the circuitry is configured to generate the prompt sentence information in a format that embeds the character string length value, the list-element count value, the character string length threshold, and the list-element count threshold as numeric metric fields within the prompt sentence information, and that includes explicit ordering constraints specifying a target number of output items or a target maximum character length for the revision proposal information.

15. The system according to claim 14, wherein the circuitry is configured to batch a plurality of prompt sentence information instances and submit the batch to the generative neural network model via the communication interface when a number of pending revision requests exceeds a batch processing threshold, and to distribute the resulting revision proposal information to the corresponding terminal devices upon receiving batch response data.

16. The system according to claim 1, wherein the circuitry is configured to switch instruction content and a revision policy encoded in the prompt sentence information based on at least one of user attribute information or language type information associated with the text data, and to generate notification message data formatted according to notification conditions specific to each terminal device and transmit the notification message data to the terminal device via the communication interface.

17. The system according to claim 16, wherein the circuitry is configured to apply a communication protocol to transmit the notification message data via at least one of an electronic communication service or an information delivery service, and to include in the notification message data at least the original text data, classification information identifying issue types detected based on the character string length value and the list-element count value, and at least a portion of the revision proposal information generated by the generative neural network model.

18. A system comprising:
circuitry configured to:
receive, via a communication interface coupled to a packet-switched network, text data from a terminal device;
analyze the text data by counting character units to produce a character string length value and by applying pattern-matching processing to detect list markers and count list elements to produce a list-element count value;
acquire a character string length threshold and a list-element count threshold from a storage device, compare the character string length value against the character string length threshold and the list-element count value against the list-element count threshold, and when at least one threshold is exceeded, select a prompt pattern from a configuration table based on which threshold was exceeded and generate prompt sentence information by inserting instruction content, the character string length value, the list-element count value, and the text data into the selected prompt pattern;
transmit request data comprising the prompt sentence information to a generative neural network model, receive response data comprising revision proposal information generated by the generative neural network model, store the character string length value, the list-element count value, the thresholds, and the revision proposal information in association in the storage device, and transmit feedback information comprising the revision proposal information and metric data to the terminal device via the communication interface; and
execute emotion analysis processing on the text data to derive emotion evaluation information, adjust the revision proposal information based on the emotion evaluation information to produce tone-adjusted modification candidate information, and store the revision proposal information and a tone adjustment result as record information to update a prompt generation condition based on the record information.

19. The system according to claim 18, wherein the circuitry is configured to complete processing from receiving the text data to transmitting the feedback information within a predetermined delay time, omit invocation of the generative neural network model when neither the character string length value exceeds the character string length threshold nor the list-element count value exceeds the list-element count threshold, and dynamically update the character string length threshold and the list-element count threshold based on accumulated record information stored in the storage device.

20. A method comprising:
receiving, via a communication interface coupled to a packet-switched network, text data from a terminal device and storing the text data in a storage device;
analyzing the text data to calculate a character string length value and a list-element count value by applying pattern-matching processing to detect individual elements of a list structure within the text data;
acquiring reference value information comprising a character string length threshold and a list-element count threshold from the storage device, comparing the character string length value and the list-element count value against the reference value information, and setting a threshold exceedance flag when at least one of the character string length value or the list-element count value exceeds the corresponding threshold;
when the threshold exceedance flag is set, selecting a prompt pattern from a plurality of stored prompt patterns based on which threshold was exceeded and generating prompt sentence information by inserting instruction content and the text data into the selected prompt pattern, and transmitting request data comprising the prompt sentence information to a generative neural network model via the communication interface;
receiving response data comprising revision proposal information generated by the generative neural network model based on the prompt sentence information, extracting the revision proposal information from the response data, and storing the character string length value, the list-element count value, the reference value information, and the revision proposal information in association with one another in the storage device; and
generating feedback information comprising the revision proposal information and the character string length value and list-element count value, and transmitting the feedback information to the terminal device via the communication interface.
